(19) United States
(12) Patent Application Publication
(10) Pub. No.: US 2026/0102901 A1
(43) Pub. Date: Apr. 16, 2026

(54) Hanging Support Structures and Coupling Components

(71) Applicant: Milwaukee Electric Tool Corporation, Brookfield, WI (US)

(72) Inventors: Steven J. Berg, JR., Wauwatosa, WI (US); Anna G. Tracy, Delafield, WI (US); Ryan M. Antenore, South Milwaukee, WI (US); Scott M. Hangartner, Richfield, WI (US); Matthew A. Lownik, Wauwatosa, WI (US)

(21) Appl. No.: 19/276,557

(22) Filed: Jul. 22, 2025

Related U.S. Application Data
(60) Provisional application No. 63/705,643, filed on Oct. 10, 2024.
(60) Provisional application No. 63/786,632, filed on Apr. 10, 2025.

(51) Int. Cl. B25H 3/04; B25H 3/02

(52) U.S. Cl. CPC B25H 3/04; B25H 3/021

(57) ABSTRACT

Various aspects of hanging tool support devices and objects that couple thereto are shown. In various embodiments, the hanging tool support devices described herein are configured to be used in conjunction with moveable walls, such as for a utility bucket. One or more of the objects that couple to the hanging tool support devices are also configured to engage with units within a modular tool storage system.

### CROSS-REFERENCE TO RELATED PATENT APPLICATIONS

The present application claims the benefit of and priority to U.S. Provisional Application No. 63/786,632, filed Apr. 10, 2025, and U.S. Provisional Application No. 63/705,643, filed Oct. 10, 2024, each of which is incorporated herein by reference in its entirety.

### BACKGROUND OF THE INVENTION

The present invention relates generally to the field of tool and equipment storage and support. The present invention relates specifically hanging support structures that couple to components compatible with a modular tool storage system.

### SUMMARY OF THE INVENTION

One embodiment of the invention relates to a method of selectably supporting a first object within a utility bucket and a vehicle storage compartment, the method including coupling the first object that includes a first modular support element to a first tool support structure within a motor vehicle via engagement between the first modular support element and the first tool support structure. The first tool support structure includes a base slidably coupled to a horizontal support surface of the motor vehicle, a first plurality of arms extending upward from the base, and a second plurality of arms extending horizontally between the first plurality of arms. The second plurality of arms are configured to detachably engage with the first modular support element of the first object. The method further includes decoupling the first object from the first tool support structure, and coupling the first object to a second tool support structure hanging from a wall of a power utility bucket via engagement between the first modular support element and the second tool support structure.

Another embodiment of the invention relates to a tool support device configured to couple to a supporting wall, the tool support device including a plate, a plurality of coupling mechanisms coupled to the plate, and a plurality of coupling structures defined by the plate. The plurality of coupling components are configured to detachably couple with first rails coupled to a wall of a motor vehicle, and the plurality of coupling components are configured to detachably couple with second rails of a support structure hanging from a wall of a power utility bucket. Each of the plurality of coupling structures includes an upper wall, a first side wall, a second side wall opposite the first side wall, a lower wall opposite the upper wall, a first rib extending from each of the lower wall and the first side wall, and a second rib extending from each of the lower wall and the second side wall.

Another embodiment of the invention relates to a container including a base configured to be slidably coupled to a horizontal support surface of a motor vehicle, a plurality of arms extending upward from the base, and a plurality of rails extending horizontally between the plurality of arms. Each rail of the plurality of rails includes a body extending between and coupled to the arms, an upper projection extending upward and laterally from the body, and a lower projection extending downward and laterally from the body. The plurality of rails are configured to detachably engage with support elements that are coupled to objects.

Another embodiment of the invention relates to a hanging tool support device configured to hang from a supporting wall. The hanging tool support device includes a first upper wall extending from a first front end to a first rear end, a first rear wall extending downward from the first rear end, a first plurality of projections extending from the first upper wall, a first front wall coupled to the first front end, a plurality of panels coupled to the first front wall and extending horizontally in front of the first front wall, a second plurality of projections extending from the first front wall, and a locking component actuating between a locked position and an unlocked position. The first upper wall interfaces against and is supported by a supporting wall. The first rear wall defines a first rear surface, and the first rear wall is rigidly engaged with the first upper wall. The first front wall defines a first front surface, and the first front wall and first rear wall define a space between the first front wall and the first rear wall, the space configured to receive the supporting wall the first upper wall is interfacing against. The first rear surface and the first front surface face away from each other. The front wall is pivotable over a first range of motion with respect to the first upper wall and the first rear wall when the locking component is in the unlocked position, and the first front wall is prevented from pivoting over the first range of motion with respect to the first upper wall and the first rear wall when the locking component is in the locked position. The locking component slidably engages with both the first plurality of projections and the second plurality of projections when in the locked position.

In a specific embodiment, the locking component includes a recess that receives both the first plurality of projections and the second plurality of projections when the locking component is in the locked position.

In a specific embodiment, the plurality of panels includes a first panel, the first panel defining a recess between the first panel and the first front wall, wherein the recess is configured to receive a locking arm extending from a first object coupled to the first panel.

In a specific embodiment, the hanging tool support device includes a second upper wall extending from a second front end to a second rear end, a second rear wall extending downward from the second rear end, a third plurality of projections extending from the second upper wall, a second front wall coupled to the second front end, and a second locking component actuating between a locked position and an unlocked position. The second upper wall interfaces against and is supported by the supporting wall. The second rear wall defines a second rear surface, and the second rear wall is rigidly engaged with the second upper wall. The second front wall defines a second front surface, and the second front wall and second rear wall define a space between the second front wall and the second rear wall. The space is configured to receive the supporting wall the upper wall is interfacing against. The second rear surface and the second front surface face away from each other. The second front wall is pivotable over the first range of motion with respect to the second upper wall and the second rear wall when the second locking component is in the unlocked position, and the second front wall is prevented from pivoting over the first range of motion with respect to the second upper wall and the second rear wall when the locking component is in the locked position. The locking component slidably engages with both the first plurality of projections and the second plurality of projections when in the locked position.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a portion of a hanging tool support device, according to an exemplary embodiment.

FIG. 2 is a side cross-section view of the hanging tool support device of FIG. 1, according to an exemplary embodiment.

FIG. 3 is a perspective view of a portion of the hanging tool support device of FIG. 1, according to an exemplary embodiment.

FIG. 4 is a perspective view of the hanging tool support device of FIG. 1, according to an exemplary embodiment.

FIG. 5 is a perspective view of the hanging tool support device of FIG. 1, according to an exemplary embodiment.

FIG. 6 is a perspective view of a portion of a hanging tool support device, according to an exemplary embodiment.

FIG. 7 is a rear perspective view of the hanging tool support device of FIG. 6, according to an exemplary embodiment.

FIG. 8 is a perspective view of a portion of a hanging tool support device, according to an exemplary embodiment.

FIG. 9 is a perspective view of the hanging tool support device of FIG. 8, according to an exemplary embodiment.

FIG. 10 is a perspective view of the hanging tool support device of FIG. 8, according to an exemplary embodiment.

FIG. 11 is a side view of a portion of a hanging tool support device, according to an exemplary embodiment.

FIG. 12 is a perspective view of the hanging tool support device of FIG. 11, according to an exemplary embodiment.

FIG. 13 is a side view of a portion of a hanging tool support device, according to an exemplary embodiment.

FIG. 14 is a perspective view of the hanging tool support device of FIG. 13, according to an exemplary embodiment.

FIG. 15 is a perspective view of a portion of a hanging tool support device, according to an exemplary embodiment.

FIG. 16 is a perspective view of a portion of the hanging tool support device of FIG. 15, according to an exemplary embodiment.

FIG. 17 is a bottom view of a male coupler, according to an exemplary embodiment.

FIG. 18 is a perspective view of a support element, according to an exemplary embodiment.

FIG. 19 is a perspective cross-section view of the support element of FIG. 18, according to an exemplary embodiment.

FIG. 20 is a perspective view of a support element, according to an exemplary embodiment.

FIG. 21 is a perspective view of the support element of FIG. 20, according to an exemplary embodiment.

FIG. 22 is a rear perspective view of the support element of FIG. 20, according to an exemplary embodiment.

FIG. 23 is a cross-section view of the support element of FIG. 20, according to an exemplary embodiment.

FIG. 24 is a perspective view of a support element, according to an exemplary embodiment.

FIG. 25 is a rear perspective view of the support element of FIG. 24, according to an exemplary embodiment.

FIG. 26 is a cross-section view of the support element of FIG. 24, according to an exemplary embodiment.

FIG. 27 is a perspective view of a support element, according to an exemplary embodiment.

FIG. 28 is a rear perspective view of the support element of FIG. 27, according to an exemplary embodiment.

FIG. 29 is a cross-section view of the support element of FIG. 27, according to an exemplary embodiment.

FIG. 30 is a perspective view of a support element, according to an exemplary embodiment.

FIG. 31 is a rear perspective view of the support element of FIG. 30, according to an exemplary embodiment.

FIG. 32 is a cross-section of a perspective view of the support element of FIG. 30, according to an exemplary embodiment.

FIG. 33 is a perspective view of a battery, according to an exemplary embodiment.

FIG. 34 is a perspective view of a female coupler that couples with the battery of FIG. 33, according to an exemplary embodiment.

FIG. 35 is a schematic cross-section view of a support element, according to an exemplary embodiment.

FIG. 36 is a schematic cross-section view of the support element of FIG. 35, according to an exemplary embodiment.

FIG. 37 is a perspective view of a hanging tool support device, according to another exemplary embodiment.

FIG. 38 is a perspective view of a portion of the hanging tool support device of FIG. 37, according to an exemplary embodiment.

FIG. 39 is a perspective view of a portion of the hanging tool support device of FIG. 37, according to an exemplary embodiment.

FIG. 40 is a perspective cross-section view of a portion of the hanging tool support device of FIG. 37, according to an exemplary embodiment.

FIG. 41 is a perspective view of a portion of the hanging tool support device of FIG. 37, according to an exemplary embodiment.

FIG. 42 is a perspective view of a portion of the hanging tool support device of FIG. 37, according to an exemplary embodiment.

FIG. 43 is a perspective view of a portion of the hanging tool support device of FIG. 37, according to an exemplary embodiment.

FIG. 44 is a schematic cross-section view of a portion of the hanging tool support device of FIG. 37, according to an exemplary embodiment.

FIG. 45 is a perspective view of a hanging tool support device, according to another exemplary embodiment.

FIG. 46 is a perspective view of the hanging tool support device of FIG. 45, according to an exemplary embodiment.

FIG. 47 is a perspective view of the hanging tool support device of FIG. 45, according to an exemplary embodiment.

FIG. 48 is a perspective view of a portion of the hanging tool support device of FIG. 45, according to an exemplary embodiment.

FIG. 49 is a perspective view of a portion of the hanging tool support device of FIG. 45, according to an exemplary embodiment.

FIG. 50 is a perspective view of a portion of the hanging tool support device of FIG. 45, according to an exemplary embodiment.

FIG. 51 is a perspective view of a portion of the hanging tool support device of FIG. 45, according to an exemplary embodiment.

FIG. 52 is a perspective view of a portion of the hanging tool support device of FIG. 45, according to an exemplary embodiment.

FIG. 53 is a perspective view of a hanging tool support device, according to another exemplary embodiment.

FIG. 54 is a perspective view of a hanging tool support device, according to another exemplary embodiment.

FIG. 55 is a schematic cross-section view of a portion of the hanging tool support device of FIG. 54, according to an exemplary embodiment.

FIG. 56 is a perspective view of a portion of the hanging tool support device of FIG. 54, according to an exemplary embodiment.

FIG. 57 is a perspective view of a hanging tool support device, according to another exemplary embodiment.

FIG. 58 is a perspective view of a portion of the hanging tool support device of FIG. 57, according to an exemplary embodiment.

FIG. 59 is a perspective view of a portion of the hanging tool support device of FIG. 57, according to an exemplary embodiment.

FIG. 60 is a perspective view of a portion of the hanging tool support device of FIG. 57, according to an exemplary embodiment.

FIG. 61 is a perspective view of a portion of the hanging tool support device of FIG. 57, according to an exemplary embodiment.

FIG. 62 is a schematic cross-section view of a portion of the hanging tool support device of FIG. 57, according to an exemplary embodiment.

FIG. 63 is a schematic cross-section view of a portion of the hanging tool support device of FIG. 57, according to an exemplary embodiment.

FIG. 64 is a perspective view of a board, according to another exemplary embodiment.

FIG. 65 is a perspective view of a portion of the board of FIG. 64, according to an exemplary embodiment.

FIG. 66 is a cross-section view of a portion of the board of FIG. 64, according to an exemplary embodiment.

FIG. 67 is a cross-section view of a portion of the board of FIG. 64, according to an exemplary embodiment.

FIG. 68 is a cross-section view of a portion of the board of FIG. 64, according to an exemplary embodiment.

FIG. 69 is a top view of a portion of the board of FIG. 64, according to an exemplary embodiment.

FIG. 70 is a perspective view of a support element, according to another exemplary embodiment.

FIG. 71 is a schematic rear of the support element of FIG. 70, according to an exemplary embodiment.

FIG. 72 is a schematic front view of the support element of FIG. 70, according to an exemplary embodiment.

FIG. 73 is a rear view of the support element of FIG. 70, according to an exemplary embodiment.

FIG. 74 is a schematic cross-section view of a hanging tool support device, according to another exemplary embodiment.

FIG. 75 is a perspective view of a portion of a lifting device that might be used with the hanging tool support device of FIG. 74, according to an exemplary embodiment.

FIG. 76 is a front view of a board, according to another exemplary embodiment.

FIG. 77 is a front view of the boards of FIG. 76, according to an exemplary embodiment.

FIG. 78 is a front view of boards, according to another exemplary embodiment.

FIG. 79 is a perspective view of a mounting element, according to another exemplary embodiment.

FIG. 80 is a perspective view of a board, according to another exemplary embodiment.

FIG. 81 is a perspective view of the mounting element of FIG. 79 and the boards of FIG. 80, according to an exemplary embodiment.

FIG. 82 is a schematic cross-section view of a hanging tool support device, according to another exemplary embodiment.

FIG. 83 is a perspective view of a portion of the hanging tool support device of FIG. 82, according to an exemplary embodiment.

FIG. 84 is a perspective view of a hanging tool support device, according to another exemplary embodiment.

FIG. 85 is a perspective view of a support element, according to another exemplary embodiment.

FIG. 86 is a front view of boards, according to another exemplary embodiment.

FIG. 87 is a perspective view of a support element, according to another exemplary embodiment.

FIG. 88 is a perspective view of a hanging tool support device, according to another exemplary embodiment.

FIG. 89 is a schematic rear view of a portion of the hanging tool support device of FIG. 88, according to an exemplary embodiment.

FIG. 90 is a schematic rear view of a portion of the hanging tool support device of FIG. 88, according to an exemplary embodiment.

FIG. 91 is a perspective view of boards, according to another exemplary embodiment.

FIG. 92 is a perspective view of a corner element boards, according to another exemplary embodiment.

FIG. 93 is a schematic cross-section view of a hanging tool support device, according to another exemplary embodiment.

FIG. 94 is a perspective view of a board, according to another exemplary embodiment.

FIG. 95 is a perspective view of a board, according to another exemplary embodiment.

FIG. 96 is a rear view of a board, according to another exemplary embodiment.

FIG. 97 is a perspective view of a hanging tool support device, according to another exemplary embodiment.

FIG. 98 is a perspective view of a portion of the hanging tool support device of FIG. 97, according to an exemplary embodiment.

FIG. 99 is a perspective view of a hanging tool support device, according to another exemplary embodiment.

FIG. 100 is a perspective view of a support element, according to another exemplary embodiment.

FIG. 101 is a front view of a hanging tool support device, according to another exemplary embodiment.

FIG. 102 is a schematic view of a portion of the hanging tool support device of FIG. 101, according to an exemplary embodiment.

FIG. 103 is a front view of a hanging tool support device, according to another exemplary embodiment.

FIG. 104 is a perspective view of a portion of the hanging tool support device of FIG. 103, according to an exemplary embodiment.

FIG. 105 is a rear view of a portion of the hanging tool support device of FIG. 103 and a support element, according to an exemplary embodiment.

FIG. 106 is a rear view of a portion of the hanging tool support device of FIG. 103, according to an exemplary embodiment.

FIG. 107 is a schematic cross-section view of a portion of the hanging tool support device of FIG. 103, according to an exemplary embodiment.

FIG. 108 is a schematic cross-section view of a portion of the hanging tool support device of FIG. 103, according to an exemplary embodiment.

FIG. 109 is a perspective view a portion of the hanging tool support device of FIG. 103, according to an exemplary embodiment.

FIG. 110 is a perspective view a portion of the hanging tool support device of FIG. 103, according to an exemplary embodiment.

FIG. 111 is a perspective view a portion of the hanging tool support device of FIG. 103, according to an exemplary embodiment.

FIG. 112 is a perspective view a portion of the hanging tool support device of FIG. 103, according to an exemplary embodiment.

FIG. 113 is a perspective view of a wall plates, according to another exemplary embodiment.

FIG. 114 is a front view of a portion of a wall plate of FIG. 113, according to an exemplary embodiment.

FIG. 115 is a perspective view of containers, according to another exemplary embodiment.

FIG. 116 is a perspective view of containers, according to another exemplary embodiment.

FIG. 117 is a detailed perspective view of a portion of the containers of FIG. 116, according to an exemplary embodiment.

FIG. 118 is an exemplary method of using one or more of the embodiments described herein, according to an exemplary method.

FIG. 119 is a perspective view of a support element, according to another exemplary embodiment.

FIG. 120 is a perspective view of the container of FIG. 115 that can be used in conjunction with the support element of FIG. 119, according to exemplary embodiments.

FIG. 121 is a perspective view of a support element, according to another exemplary embodiment.

FIG. 122 is a perspective view of two support elements, according to another exemplary embodiment.

FIG. 123 is a perspective view of a support element, according to another exemplary embodiment.

FIG. 124 is a perspective view of the support element of FIG. 123, according to an exemplary embodiment.

FIG. 125 is a perspective view of a support element, according to another exemplary embodiment.

### DETAILED DESCRIPTION

Referring generally to the figures, various embodiments of support mechanisms for components, such as components that are compatible with modular storage units are shown. Various embodiments of hanging tool support devices are shown that can be coupled to buckets for users to work in, such as buckets sized to receive one or two people and that are elevated, such as to work on power lines or other elevated items. The hanging tool support devices described herein detachably couple with the buckets, thereby facilitating the users attaching different devices to the buckets, or removing the devices from the buckets to clean the buckets, such as by tilting the buckets upside down. Also described herein are support elements that detachably couple to the devices and that detachably couple within a modular storage system.

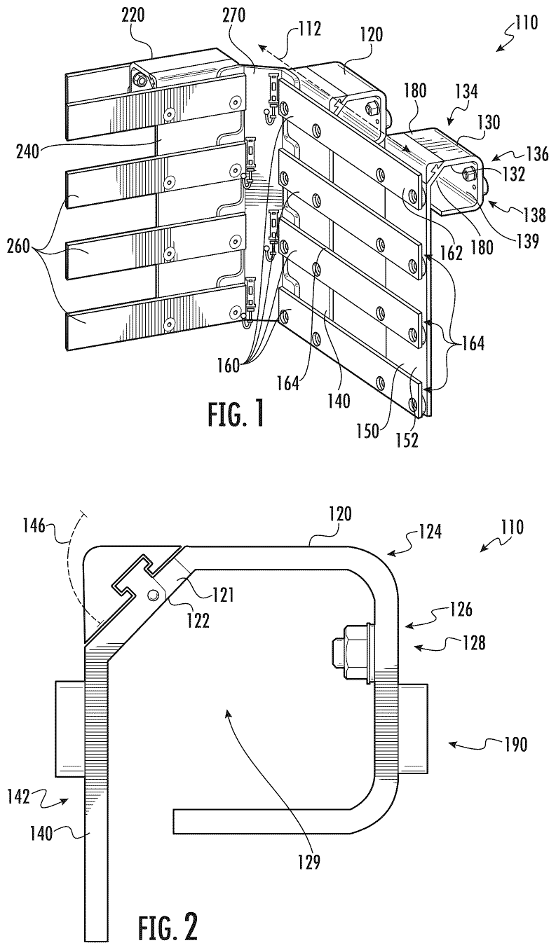

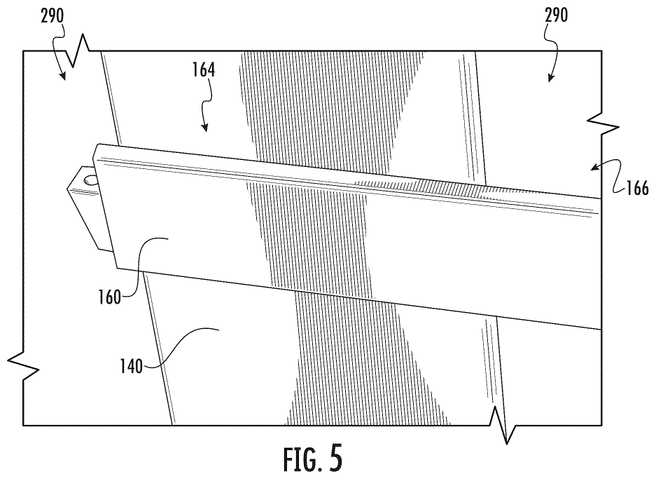

Referring to FIGS. 1-5, various aspects of hanging tool support device 110 are shown. Hanging tool support device 110 includes first upper wall 120, second upper wall 130, first front wall 140, second front wall 150, and panels 160. As will be explained, first upper wall 120 and second upper wall 130 are each pivotally coupled to first front wall 140 and second front wall 150, thereby permitting hanging tool support device 100 to be hung from and removed from supporting wall 290.

First upper wall 120 extends from first front end 122 to first rear end 124, the first upper wall 120 interfacing against and supported by a supporting wall, such as supporting wall 290 of a utility bucket. First rear wall 126 extends downward from first rear end 122, the first rear wall 126 defining a first rear surface 128. First rear wall 126 is rigidly engaged with the first upper wall 120, such as via being integrally molded together. First plurality of projections 170 extend from the first upper wall 120, such as from angled portion 121 of first upper wall 120. Space 129 is defined between first rear wall 126 and first front wall 140.

Second upper wall 130 is structurally similar to first upper wall 120. In particular, second upper wall 130 extends from second front end 132 to second rear end 134, the second upper wall 130 interfacing against and supported by a supporting wall, such as supporting wall 290 of a utility bucket. Second rear wall 136 extends downward from second rear end 132, the second rear wall 136 defining a second rear surface 138. Second rear wall 136 is rigidly engaged with the second upper wall 120, such as via being integrally molded together. First plurality of projections 170 extend from second upper wall 130, such as from angled portion of second upper wall 130. Space 139 is defined between second rear wall 136 and second front wall 150.

First front wall 140 is coupled to first front end 122, the first front wall 140 defining a first front surface 142. First front wall 140 and first rear wall 126 define a space 129 between the first front wall 140 and the first rear wall 126, the space 129 configured to receive the supporting wall 290 that the first upper wall 120 is interfacing against. The rear surface 128 and the front surface 142 face away from each other.

Second front wall 150 is structurally similar to first front wall 140. In particular, second front wall 150 is coupled to second front end 132, the second front wall 150 defining a second front surface 152. Second front wall 150 and second rear wall 136 define a space 129 between the second front wall 150 and the second rear wall 136, the space 129 configured to receive the supporting wall 290 that the second upper wall 130 is interfacing against. The second rear surface 138 and the second front surface 152 face away from each other.

First front wall 140 and second front wall 150 are pivotally coupled to first upper wall 120 and second upper wall 130, respectively, such that first front wall 140 and second front wall 150 pivot range of motion 146 about axis 112 with respect to first upper wall 120 and second upper wall 130. First front wall 140 and second front wall 150 include second plurality of projections 172 interface with first plurality of projections 170.

A plurality of panels 160, including first panel 162, are rigidly coupled to first front wall 140 and second front wall 150. Panels 160 extend horizontally in front of the first front wall 140 and second front wall 150.

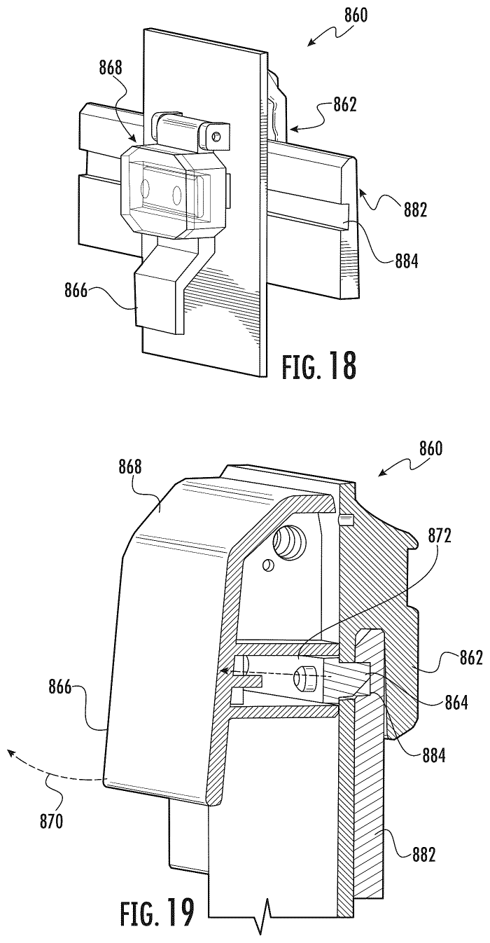

Panels 160 and front wall 140 define first recess 164 configured to receive a locking tongue from a support element (see FIGS. 18-35). Panels 160 and supporting wall 290 define second recess 166 configured to receive a locking tongue from a support element (see FIGS. 18-35). In some use cases, second recess 166 is configured to receive an object inserted into the top of hanging tool support device 110 behind multiple panels 160, such as all of the panels 160. For example, the bar of a chain saw could be inserted into second recesses 166, thereby securing the chain saw.

Hanging tool support device 110 includes locking component 180 actuating between a locked position and an unlocked position. The front walls 140, 150 are pivotable over a first range of motion 146 with respect to the upper walls 120, 130 and the rear wall 126, 136 when the locking component is in the unlocked position, and the front walls 140, 150 are prevented from pivoting over the first range of motion 146 with respect to the upper walls 120, 130 and the rear walls 126, 136 when the locking component is in the locked position. Locking component 180 slidably engages with both the first plurality of projections 170 and the second plurality of projections 172 when in the locked position.

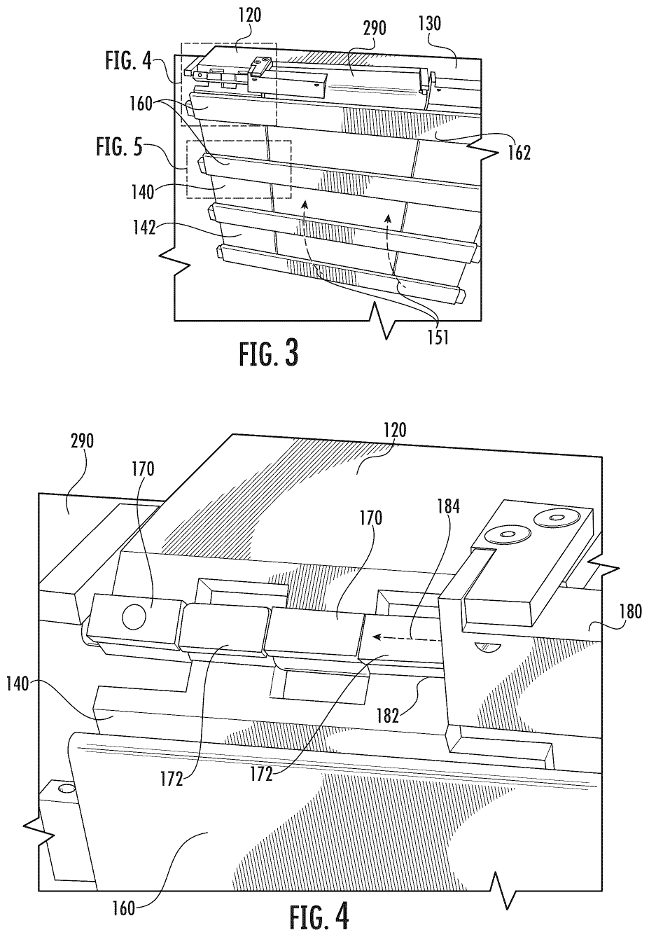

Referring to FIGS. 3-4, locking component 180 is disengaged from the first plurality of projections 170 and the second plurality of projections 172 when in the unlocked position, thereby permitting hanging tool support device 110 to be disengaged from support wall 290. In particular, front walls 140, 150 are permitted to pivot upward and away from rear walls 126, 136 in direction 151 thereby permitting the user to lift up hanging tool support device 110 away from support wall 290.

When hanging tool support device 110 is placed back on supporting wall 290, front walls 140, 150 are pivoted towards rear walls 126, 136. Then, locking component 180 is slid in direction 184 over first plurality of projections 170 and the second plurality of projections 172 to lock hanging tool support device 110 and thereby prevent disengagement of hanging tool support device 110 from supporting wall 290. In particular, locking component 180 includes recess 182 that receives both the first plurality of projections 170 and the second plurality of projections 172 when the locking component 180 is in the locked position. The user can secure tightening element 190 against support wall 290 to reduce an amount of wiggling and/or slack between hanging tool support device 110 and supporting wall 290.

Hanging tool support device 110 also includes third upper wall 220, which is similar to first upper wall 120, third front wall 240, which is similar to first front wall 140, and panels 260, which are similar to panels 160. Corner element 270 couples third upper wall 220 and first upper wall 120 across a corner of the utility bucket

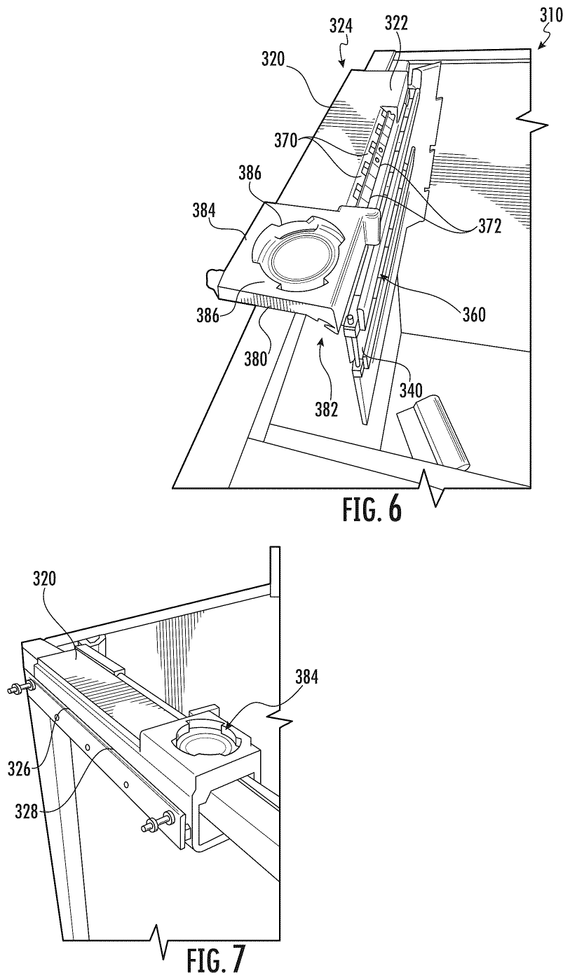

Referring to FIGS. 6-7, various aspects of hanging tool support device 310 are shown. Hanging tool support device 310 is substantially the same as hanging tool support device 110 except for the differences discussed herein. In particular, upper wall 320 extends continuously across most of hanging tool support device 310.

Upper wall 320 extends from front end 322 to rear end 324. Rear wall 326 extends downward from rear end 324 and defines rear surface 328. In various embodiments, rear wall 326 is rigidly coupled to upper wall 320, such as via being integrally molded together. Rear wall 326 defines rear surface facing away from front wall 340. One or more panels 360 extend in front of and are coupled to front wall 340.

First plurality of projections 370 extend from front wall 340, and second plurality of projections 372 extend from upper wall 320. Locking component 380 slidably engages and disengages with first plurality of projections 370 and second plurality of projections 372 to lock and unlock hanging tool support device 310 from being coupled to a supporting wall. In particular, recess 382 receives first plurality of projections 370 and second plurality of projections 372.

Locking component 380 includes a recess 384 that receives a beverage container. In various embodiments, recess 384 includes a plurality of protrusions 386 that circumferentially extend around recess 384 and inward towards a center of recess 384, thereby detachably engaging protrusions extending outward from a base of a beverage container.

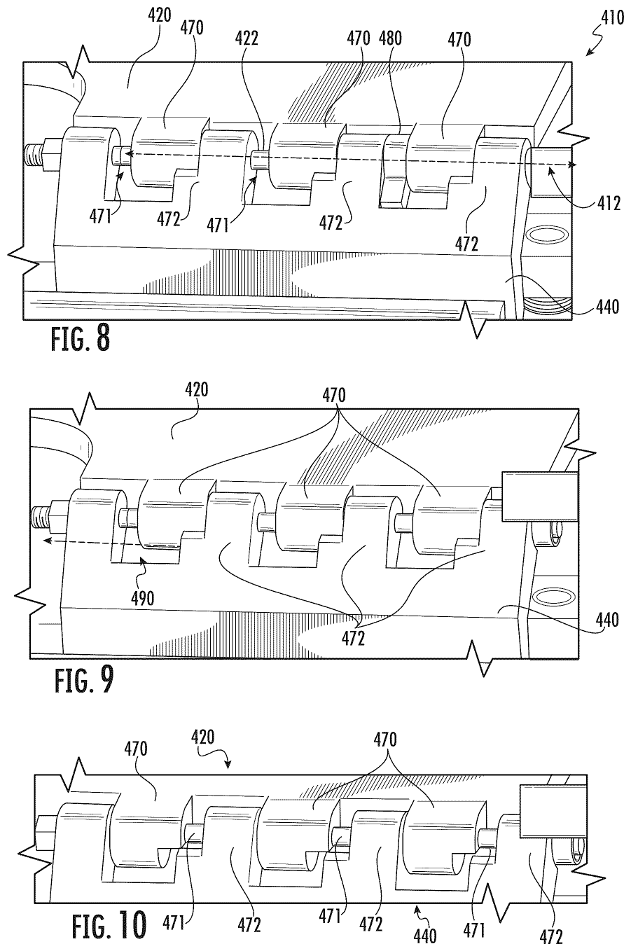

Referring to FIGS. 8-10, various aspects of hanging tool support device 410 are shown. Hanging tool support device 410 is substantially the same as hanging tool support device 110 or hanging tool support device 310 except for the differences discussed herein. In particular, hanging tool support device 410 includes locking components 480 that secure hanging tool support device 410 in the locked position.

Hanging tool support device 410 includes upper wall 420 including first plurality of projections 470 extending from front end 422 of upper wall 420. Front wall 440 includes second projection of projections 472. Upper wall 420 pivots about axis 412 with respect to front wall 440, such as when hanging tool support device 410 is in the unlocked position.

When hanging tool support device 410 is in the locked position (FIG. 8), locking component 480 is engaged with cylinder 471 to prevent upper wall 420 and front wall 440 sliding with respect to each other. As a result, first plurality of projections 470 and second plurality of projections 472 engage with each other to prevent front wall 440 pivoting away from upper wall 420, and therefore hanging tool support device 410 cannot be removed from a supporting wall of a utility bucket.

When locking component 480 is removed, front wall 440 is permitted to slide in direction 490 with respect to upper wall 420. As a result, front wall 440 is permitted to pivot away from upper wall 420, and as a result hanging tool support device 410 can be detached from a supporting wall of the utility bucket.

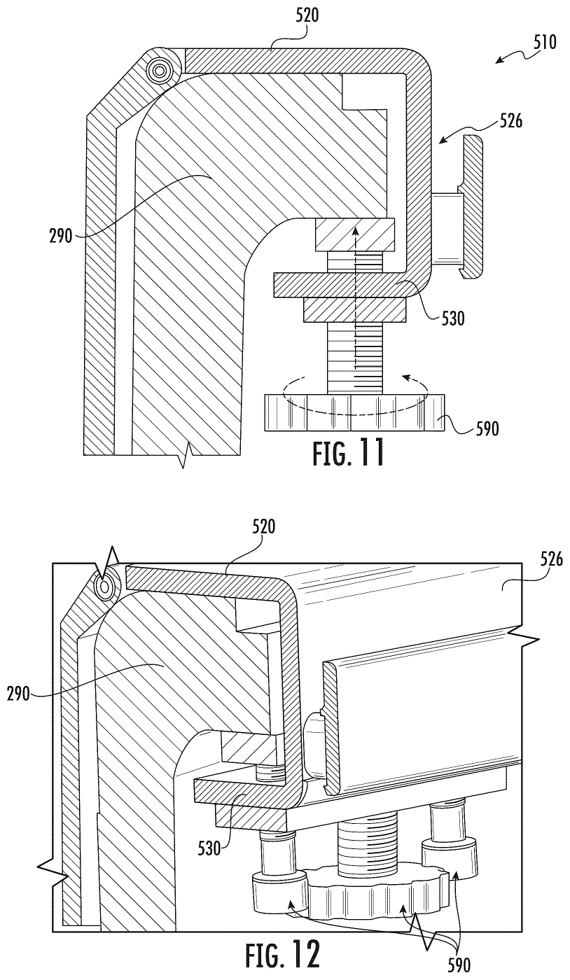

Referring to FIGS. 11-12, various aspects of hanging tool support device 510 are shown. Hanging tool support device 510 is substantially the same as hanging tool support device 110, hanging tool support device 310 or hanging tool support device 410 except for the differences discussed herein. In particular, hanging tool support device 510 includes tightening element 590.

Hanging tool support device 510 includes upper wall 520, rear wall 526, and bottom wall 530. Tightening element 590 is coupled to bottom wall 530 and secures hanging tool support device 510 to supporting wall 290.

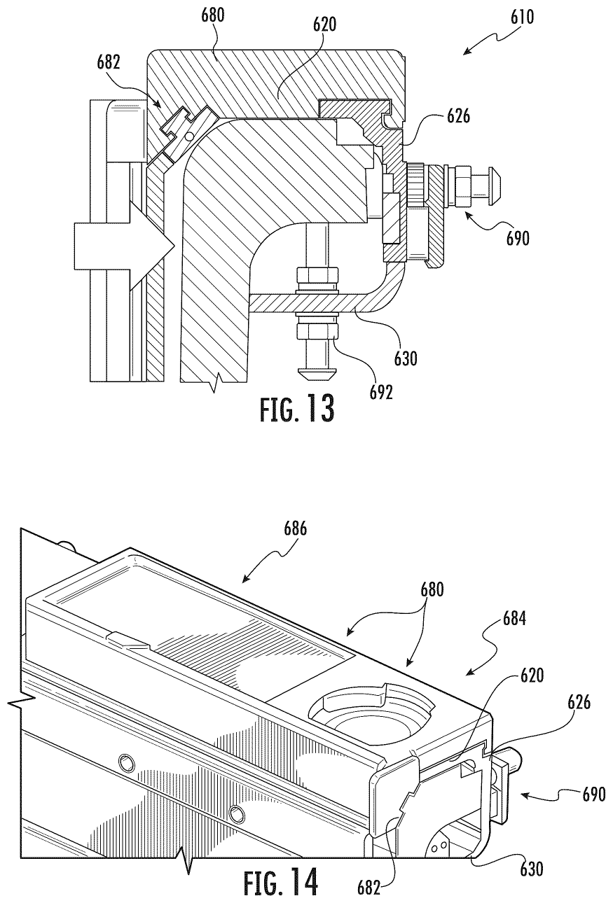

Referring to FIGS. 13-14 various aspects of hanging tool support device 610 are shown. Hanging tool support device 610 is substantially the same as hanging tool support device 110, hanging tool support device 310, hanging tool support device 410, or hanging tool support device 510 except for the differences discussed herein. In particular, hanging tool support device 610 includes tightening element 690 and includes tightening element 692.

Hanging tool support device 610 includes upper wall 620, rear wall 626, and bottom wall 630. Tightening element 692 is coupled to bottom wall 630 and secures hanging tool support device 610 to supporting wall 290, and tightening element 690 is coupled to rear wall 626 and also secures hanging tool support device 610 to supporting wall 290. In use, one or both of tightening elements 690, 692 may be used to secure hanging tool support device 610 hanging tool support device 610.

Hanging tool support device 610 includes locking component 680. Locking component includes tray 686, which in various embodiments is magnetic to retain magnetically responsive elements (e.g., ferrous metal), beverage container holder 684, and channel 682. Channel 682 receives projections extending from upper wall 620 and front wall to lock the position of hanging tool support device 610.

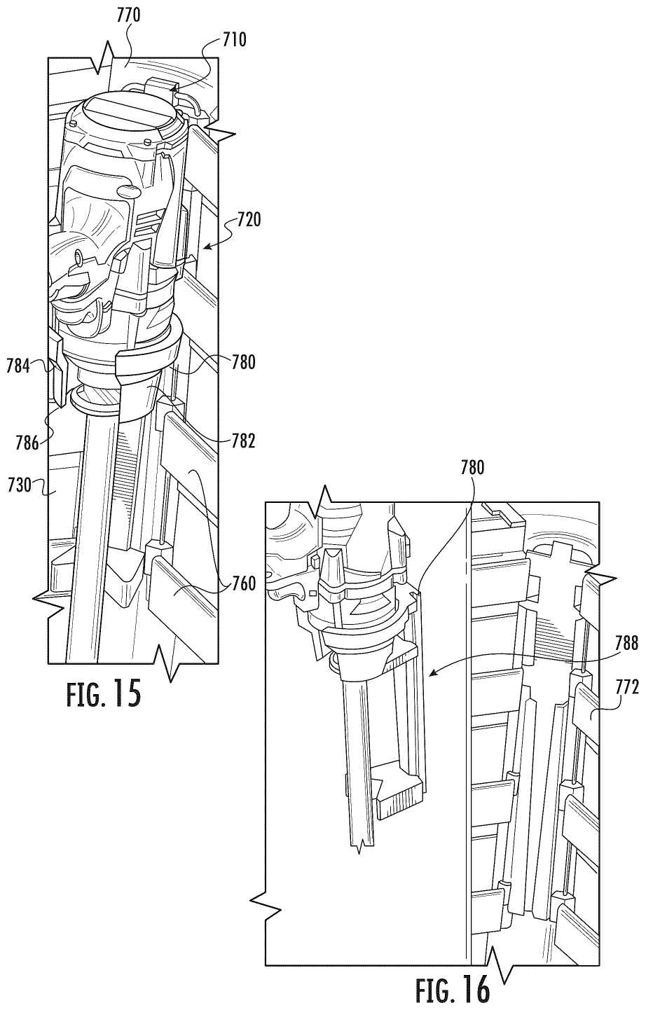

Referring to FIGS. 15-16 various aspects of hanging tool support device 710 are shown. Hanging tool support device 710 is substantially the same as hanging tool support device 110, hanging tool support device 310, hanging tool support device 410, hanging tool support device 510, or hanging tool support device 610 except for the differences discussed herein. In particular, hanging tool support device 710 includes corner element 770.

Corner element 770 is coupled to first front wall 720 and second front wall 730, thereby permitting hanging tool support device 710 to be coupled to the corner location of a utility bucket. Panels 760 are coupled to front of first front wall 720 and second front wall 730.

Corner element 770 includes mount 780 and tongues 772. Tongues 772 of corner element 770 slidably and detachably engage with ribs 788 of mount 780. Mount 780 includes first arcuate portion 782, second arcuate portion 784, and recess 786 between first arcuate portion 782 and second arcuate portion 784. In various embodiments, first arcuate portion 782 and second arcuate portion 784 extend circumferentially around a central axis. Corner element 770 is configured to receive and support a tool, such as a power drill.

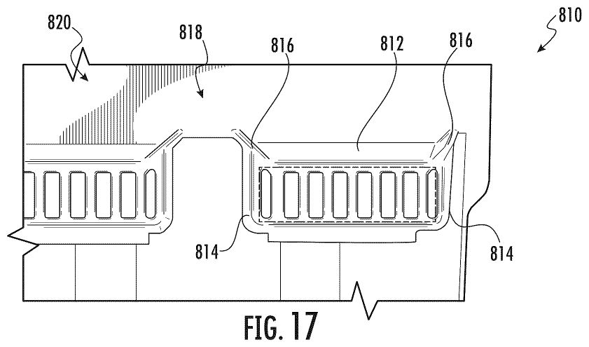

Referring to FIG. 17, various aspects of male coupler 810 are provided. Male coupler 810 extends from surface 818, such as from an object, such as a tool storage container or a tool, such as a hand tool.

Male coupler 810 includes body 812 extending upward from surface 818 of object 820. In various embodiments, at least a portion of body 812, such as most of body 812, is formed from a magnet. By forming body 812 from a magnet, male coupler 810 can be coupled to a magnetically responsive object, such as a metal wall. As a result, a user can couple the object 820 to a metal object so the user can then access the contents of the object more easily.

Male coupler 810 includes tongues 814 extending from body 812 in opposing directions. In use, tongues 814 engage with ribs of a female coupler (e.g., see tongues 1132 of female coupler in FIG. 34) to engage the object 820 to the female coupler.

Male coupler 810 includes one or more back walls 816 extending from surface 818 and body 812. In use, back walls 816 prevent ribs of a female coupler from sliding past male coupler 810, thereby maintaining engagement of male coupler 810 the female coupler.

Referring to FIGS. 18-19, various aspects of support element 860 are provided. Support element 860 is configured to be detachably reversibly mechanically coupled to an object, such as panel 882 on a wall.

Support element 860 includes tongue 862 that engages on the side of panel 882 opposite from body 868 of support element 860. Support element 860 includes protrusion 864 that engages within channel 884 of panel 882.

In use, a user slides support element 860 down to panel 882 such that tongue 862 engages around panel 882. Then, protrusion 864 engages under panel 882 to secure support element 860 to panel 882.

To remove support element 860 from panel 882, handle 866 is moved in direction 870. This causes protrusion 864 to move in direction 872, and as a result protrusion 864 disengages from panel 882. In various embodiments, protrusion is spring-biased in the direction opposite direction 872.

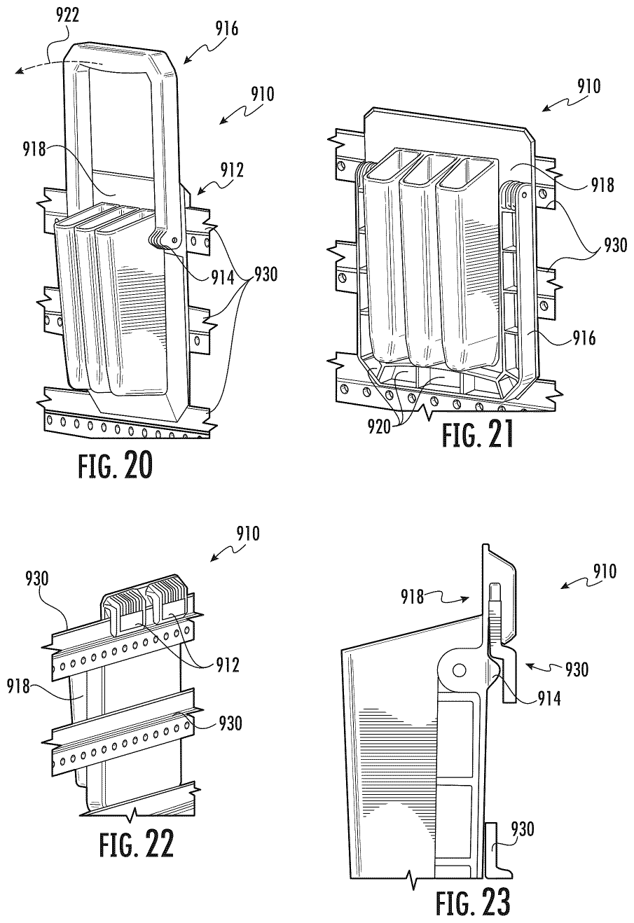

Referring to FIGS. 20-23, various aspects of support element 910 are provided. Support element 910 is substantially the same as support element 860 except for the differences discussed herein. Support element 910 is configured to be detachably reversibly mechanically coupled to an object, such as panel 930 on a wall.

Support element 910 includes tongue 912 that engages on the side of panel 930 opposite from body 918 of support element 910. Support element 910 includes protrusion 914 that engages under panel 930.

In use, a user slides support element 910 down to panel 930 such that tongue 912 engages around panel 930. Then, protrusion 914 engages under panel 930 to secure support element 910 to panel 930.

Referring to FIG. 20, handle 916 is in the unlocked position and thus support element 910 can be removed from panel 930. Handle 916 is moved in direction 922 to transition to the locked position. In the locked position (FIG. 21), protrusion 914 of handle 916 engages below panel 930.

Compartments 920 are coupled to body 918 of support element 910. Compartments 920 are empty areas configured to receive and store objects, such as tools and/or equipment.

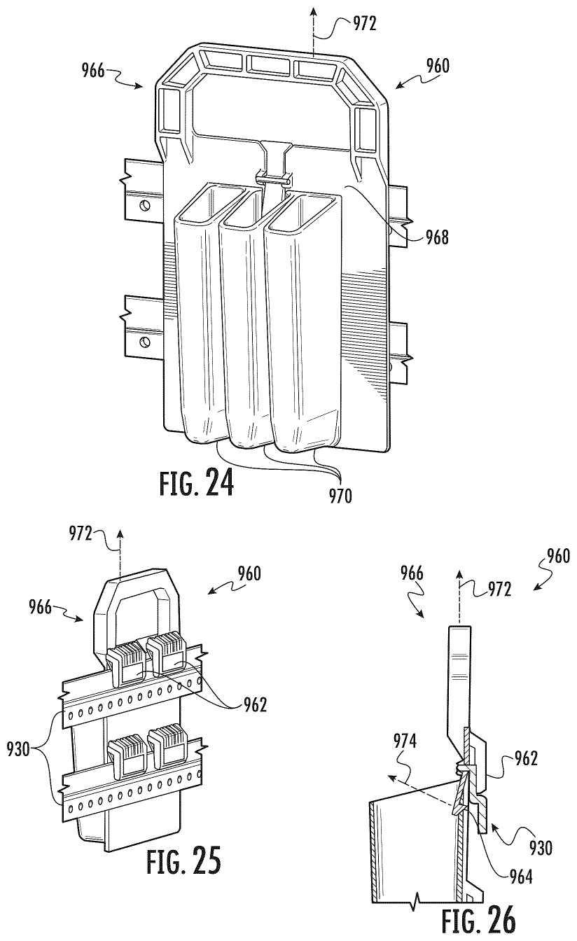

Referring to FIGS. 24-26, various aspects of support element 960 are provided. Support element 960 is substantially the same as support element 860 or support element 910 except for the differences discussed herein. Support element 960 is configured to be detachably reversibly mechanically coupled to an object, such as panel 930 on a wall.

Support element 960 includes tongue 962 that engages on the side of panel 930 opposite from body 968 of support element 960. Support element 960 includes protrusion 964 that engages under panel 930. Support element 960 includes compartments 970 configured to receive and store equipment and/or tools.

In use, a user slides support element 960 down to panel 930 such that tongue 962 engages around panel 930. Then, protrusion 964 engages under panel 930 to secure support element 960 to panel 930.

Referring to FIG. 25, handle 966 is shown in the locked position thus support element 960 can be removed from panel 930. Handle 966 is moved in direction 972 to transition to the unlocked position, thereby causing protrusion 964 to move in direction 974 and disengage from panel 930. In the unlocked position (FIG. 26), protrusion 964 no longer engages below panel 930, so support element 960 can be decoupled from panel 930.

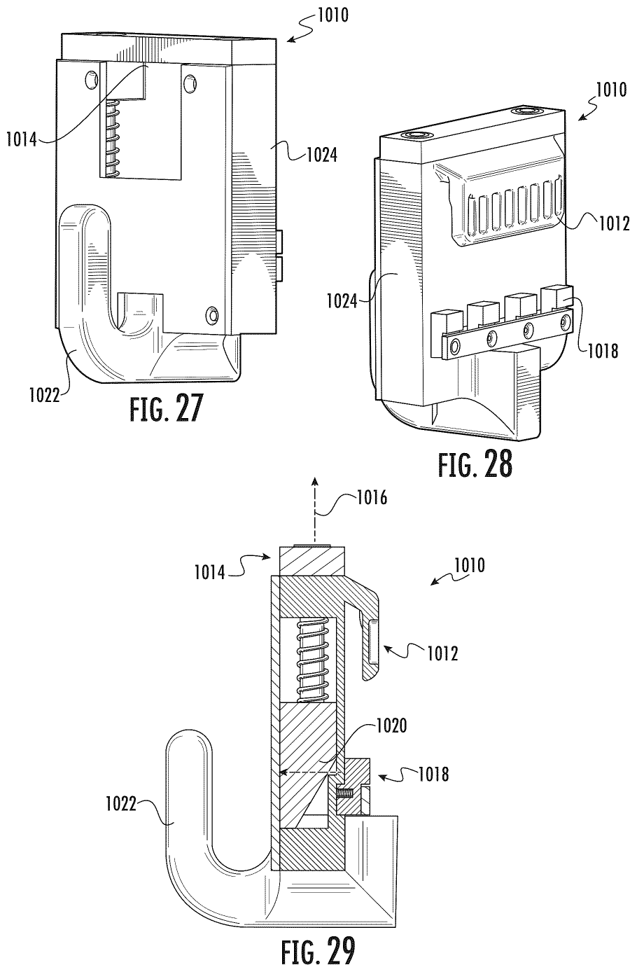

Referring to FIGS. 27-29, various aspects of support element 1010 are provided. Support element 1010 is substantially the same as support element 860, support element 910 or support element 960 except for the differences discussed herein. Support element 1010 is configured to be detachably reversibly mechanically coupled to an object, such as a panel on a wall.

Support element 1010 includes tongue 1012 that engages on the side of a panel opposite from body 1024 of support element 1010. Support element 1010 includes protrusion 1018 that engages under panel. In various embodiments, protrusion 1018 is spring biased opposite direction 1020.

In use, a user slides support element 1010 down to panel such that tongue 1012 engages around panel. Then, protrusion 1018 engages under panel to secure support element 1010 to the panel. Then the user can attach objects to support element 1010, such as by hanging an object on hook 1022.

To disengage support element 1010 from a panel, handle 1014 is moved in direction 1016. As a result, protrusion 1018 moves in direction 1020. Then, the user can move support element 1010 upward with respect to the panel to disengage the support element 1010 from the panel.

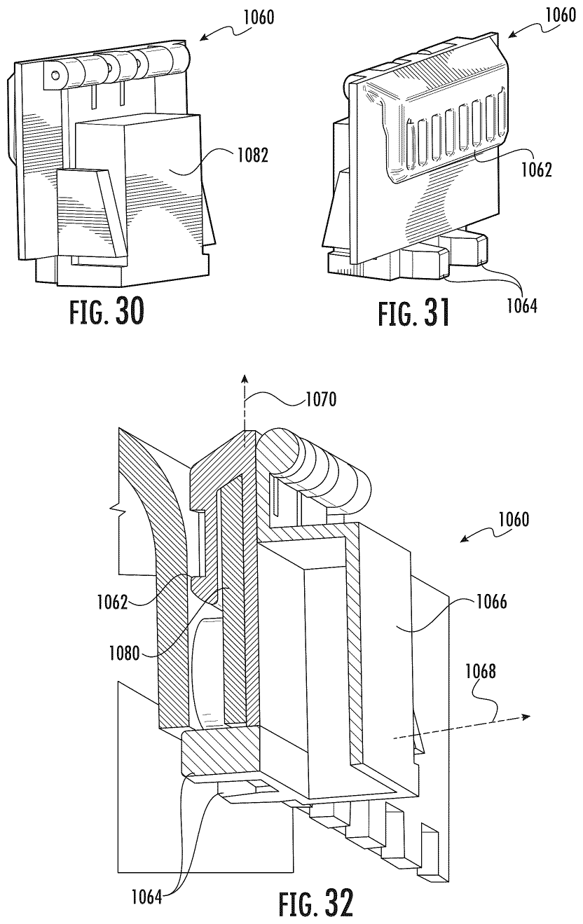

Referring to FIGS. 30-32, various aspects of support element 1060 are provided. Support element 1010 is substantially the same as support element 860, support element 910, support element 960, or support element 1010 except for the differences discussed herein. Support element 1060 is configured to be detachably reversibly mechanically coupled to an object, such as a panel 1080 on a wall.

Support element 1060 includes tongue 1062 that engages on the side of a panel 1080 opposite from body 1024 of support element 1010. Support element 1010 includes protrusion 1018 that engages under panel.

In use, a user slides support element 1060 down to panel 1080 such that tongue 1062 engages around panel 1080. Then, protrusion 1064 engages under panel 1080 to secure support element 1060 to the panel 1080. Then the user can attach objects to support element 1060.

In various embodiments, handle 1066 is spring biased opposite direction 1068. To disengage support element 1060 from a panel 1080, handle 1066 is moved in direction 1068. As a result, protrusions 1064 move in direction 1068, thereby disengaging protrusions 1064 from panel 1080. Then, the user can move support element 1060 upward in direction 1070 with respect to the panel 1080 to disengage the support element 1060 from the panel 1080.

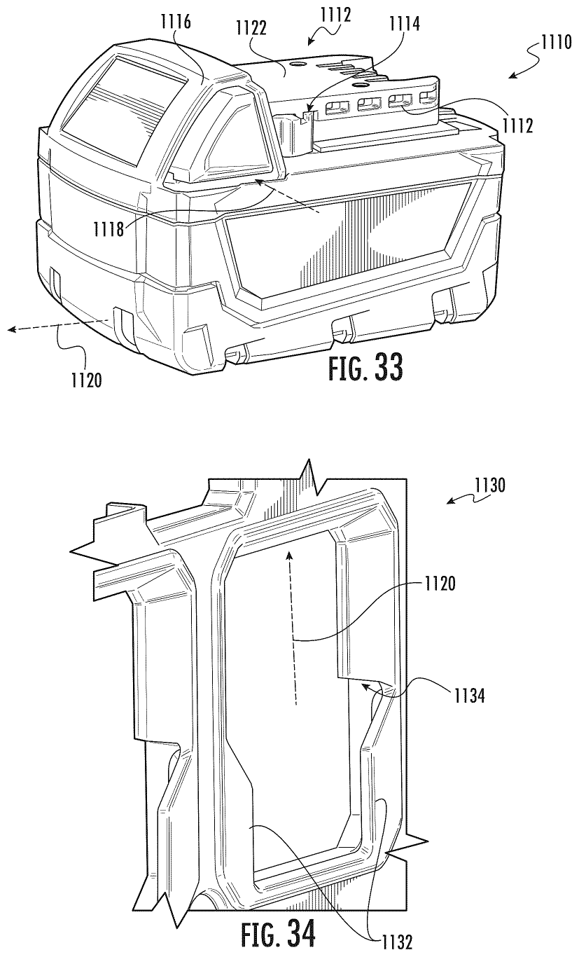

Referring to FIGS. 33-34, various aspects of battery 1110 and female coupler 1130 are provided. Battery 1110 is configured to be detachably reversibly mechanically coupled to a female coupler 1130. Battery 1110 is configured to be charged and then attached to a power tool, at which point battery 1110 provides electrical energy to the tool.

Battery 1110 includes ribs 1112 extending outward from body 1122. Protrusions 1114 are slidably engaged with body 1122 and actuate between an extended position (FIG. 33) and a retracted position. Buttons 1116 are also slidably engaged with body 1122.

Female coupler 1130 includes tongues 1132 and sidewalls 1134. In use, ribs 1112 engage underneath tongues 1132 to engage battery 1110 with female coupler 1130. Protrusions 1114 of battery 1110 engage against sidewalls 1134 to prevent battery 1110 from sliding upward in direction 1120.

In use, to disengage battery 1110 from female coupler 1130 a user presses button 1116 inward in direction 1118 and a result protrusion 1114 also moves inward in direction 1118. Then the user can slide battery 1110 in direction 1120 with respect to female coupler 1130.

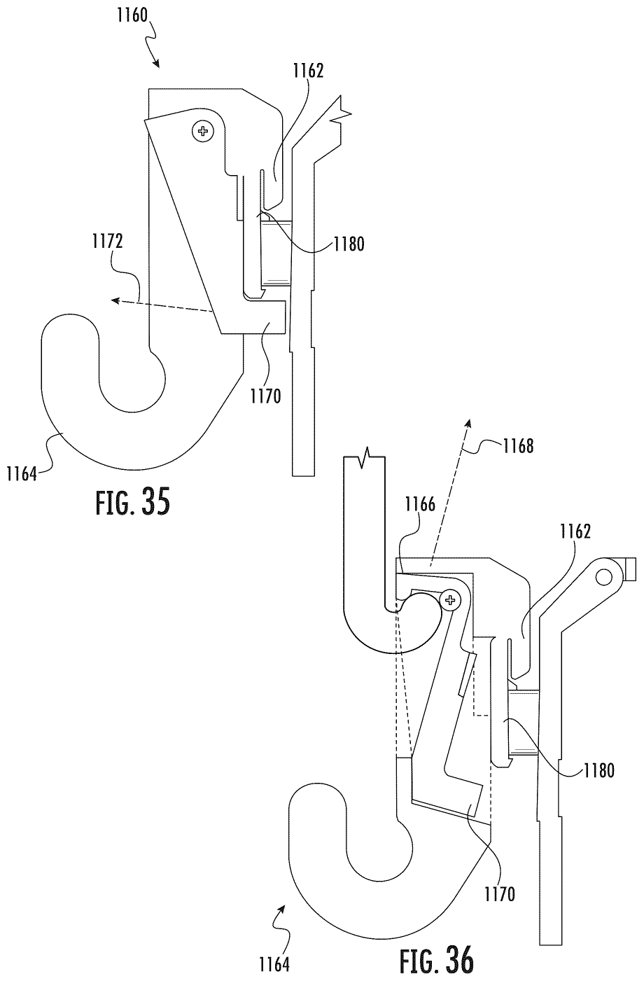

Referring to FIGS. 35-36, various aspects of support element 1160 are provided. Support element 1160 is substantially the same as support element 860, support element 910, support element 960, support element 1010 or support element 1060 except for the differences discussed herein. Support element 1160 is configured to be detachably reversibly mechanically coupled to an object, such as a panel 1180 on a wall.

Support element 1160 includes tongue 1162 that engages on the side of a panel 1180 opposite from hook 1164 of support element 1010. Support element 1060 includes protrusion 1170 that engages under panel.

In use, a user slides support element 1160 down to panel 1180 such that tongue 1162 engages around panel 1180. Then, protrusion 1170 engages under panel 1180 to secure support element 1160 to the panel 1180. Then the user can attach objects to hook 1164.

To disengage support element 1160 from a panel 1180, handle 1166 is moved in direction 1168. As a result, protrusion 1170 move in direction 1172, thereby disengaging protrusion 1170 from panel 1180. Then, the user can move support element 1160 upward with respect to the panel 1180 to disengage the support element 1160 from the panel 1180.

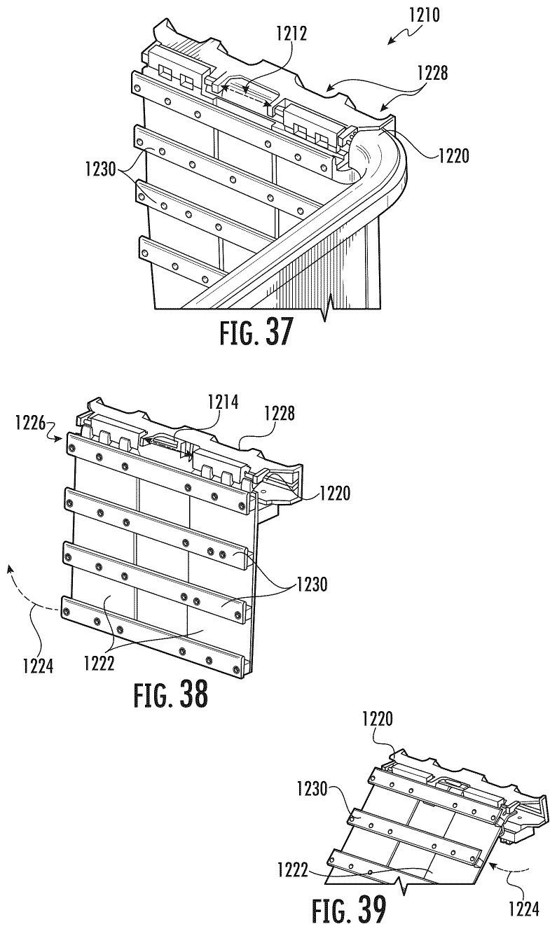

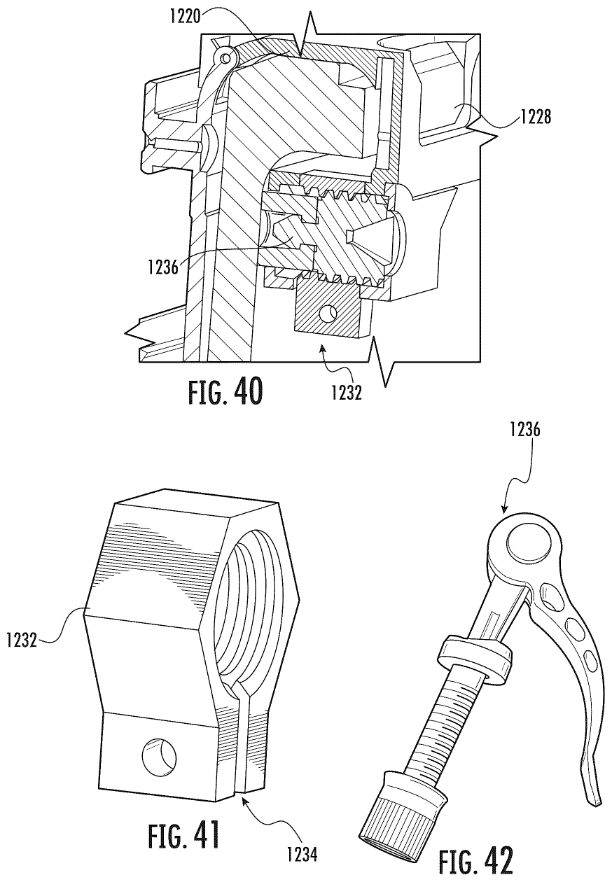

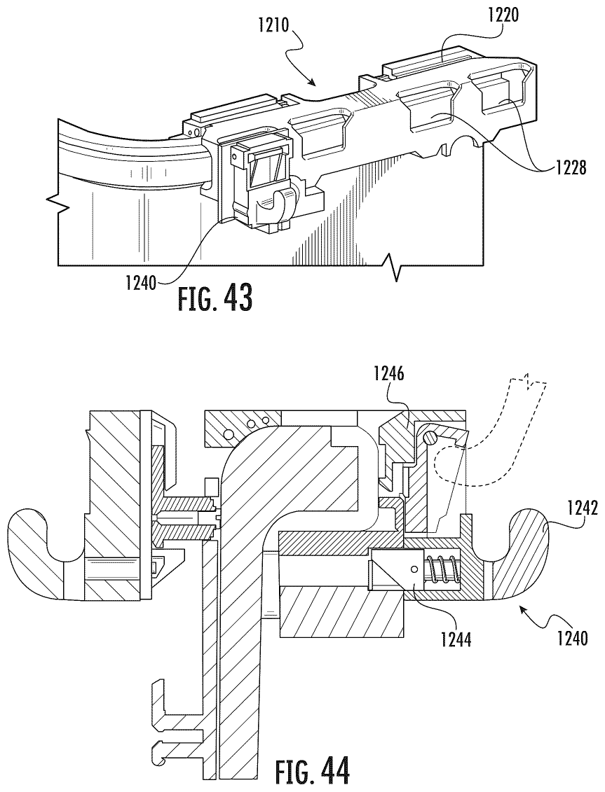

Referring to FIGS. 37-44, various aspects of hanging tool support device 1210 are shown. Hanging tool support device 1210 is substantially the same as hanging tool support device 110, hanging tool support device 310, hanging tool support device 410, hanging tool support device 510, hanging tool support device 610 or hanging tool support device 710 except for the differences discussed herein.

Hanging tool support device 1210 includes upper wall 1220 pivotally coupled to front wall 1222 such that upper wall 1220 rotates about axis 1212 with respect to front wall 1222. Hanging tool support device 1210 includes lockers 1214 that slide along axis 1212 to actuate between a locked position, in which upper wall 1220 can pivot with respect to front wall 1222, and an unlocked position, in which upper wall 1220 cannot pivot with respect to front wall 1222. When lockers 1214 are in the unlocked position (e.g., FIG. 39), upper wall 1220 can pivot in direction 1224 with respect to front wall 1222. In various embodiments, hanging tool support device 1210 includes one or more detent, such as spring biased balls, that bias the lockers 1214 into the locked and/or unlocked positions.

Front wall 1222 extends downward from front end 1226 of upper wall 1220. Couplers 1228 extend from a rear portion of upper wall 1220. One or more rails 1230 are coupled to front wall 1222 and configured to be coupled to by various support elements. In various embodiments hanging tool support device 1210 includes one or more spacers between front wall 1222 and rails 1230 to provide a gap therebetween, which allows objects to fall through the hanging tool support device 1210 without debris building up behind the rails 1230.

When securing hanging tool support device 1210 to a wall, such as on a utility bucket, after hanging tool support device 1210 is placed on the wall the clamp 1236 is secured against the wall to secure the hanging tool support device 1210 to the wall. In various embodiments clamp 1236 extends through fastener 1232, which includes a slit 1234 that provides flexibility to fastener 1232 to facilitate clamp 1236 actuating between a locked and unlocked position. Applicant has observed that this structure for fastener 1232 and clamp 1236 facilitates keeping hanging tool support device 1210 coupled to a wall even when there are bumps and vibrations.

Support element 1240 is configured to couple to couplers, such as couplers 1238. Support element 1240 includes hook 1242 extending away from coupler 1238, latch 1244 that interfaces with couplers 1238 when coupler 1246 of support element 1240 is engaged with one of couplers 1238. Latch 1244 slides with respect to support element 1240 to actuate between a locked and unlocked position.

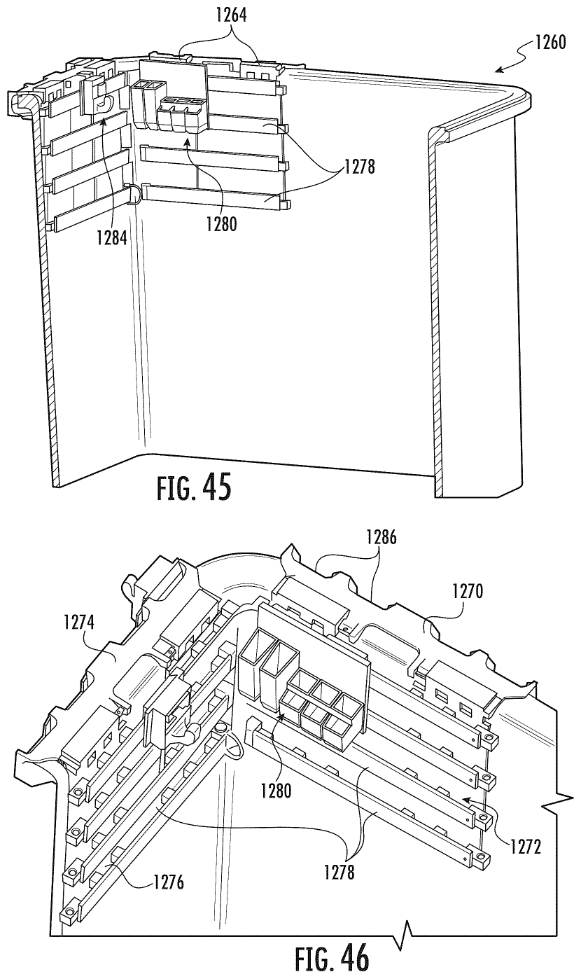

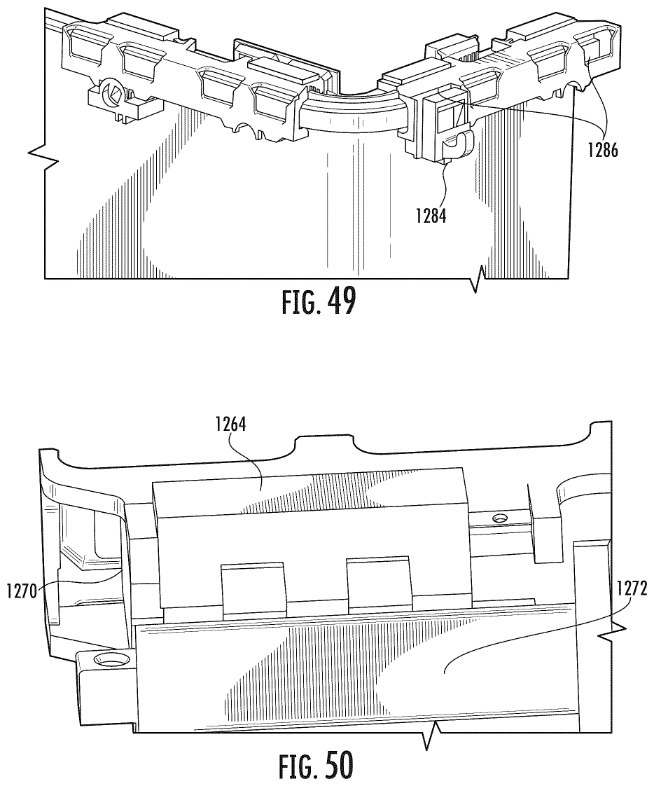

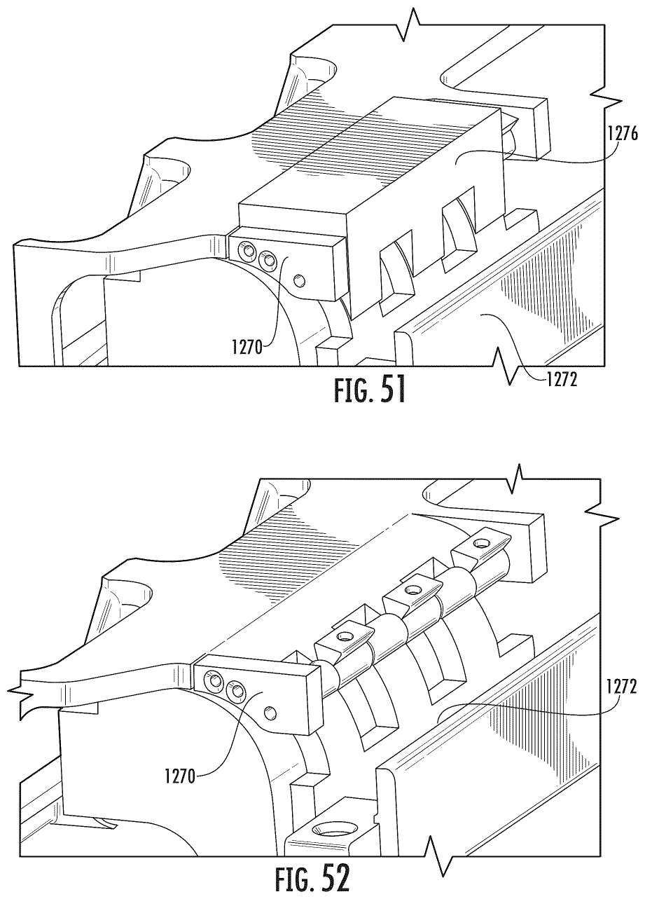

Referring to FIGS. 45-52, various aspects of hanging tool support device 1260 are shown. Hanging tool support device 1260 is substantially the same as hanging tool support device 110, hanging tool support device 310, hanging tool support device 410, hanging tool support device 510, hanging tool support device 610, hanging tool support device 710 or hanging tool support device 1210 except for the differences discussed herein.

Hanging tool support device 1260 includes upper walls 1270, 1274 and front walls 1272, 1276 pivotally coupled to upper walls 1270, 1274. Lockers 1264 secure the orientation of upper walls 1270, 1274 with respect to front walls 1272, 1276.

Hanging tool support device 1260 includes rails 1278 configured to be coupled to various support elements, such as support element 1280 and support element 1284. Support element 1280 includes one or more containers 1282. In various embodiments rails 1278 are disposed a distance from wall 1290 to permit objects to be slid between rails 1278 and wall 1290. Hanging tool support device 1260 includes couplers 1286 facing outward from the wall 1290 to which hanging tool support device 1260 is coupled.

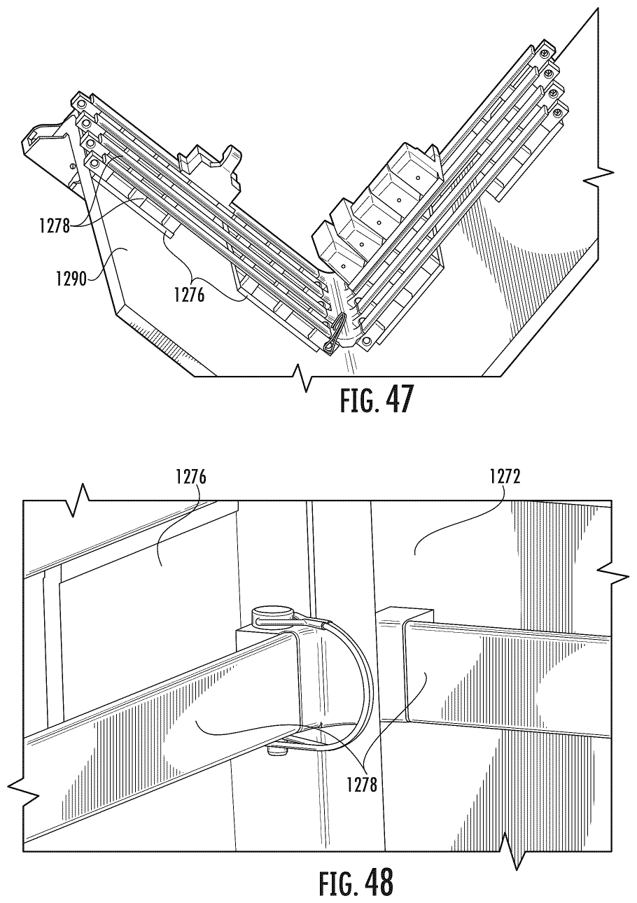

Referring to FIGS. 47-48, in various embodiments rails 1278 are detachably coupled to an object, such as one of front walls 1272, 1276 and/or a corner element that is configured to rest within a corner of the utility bucket that is coupled to.

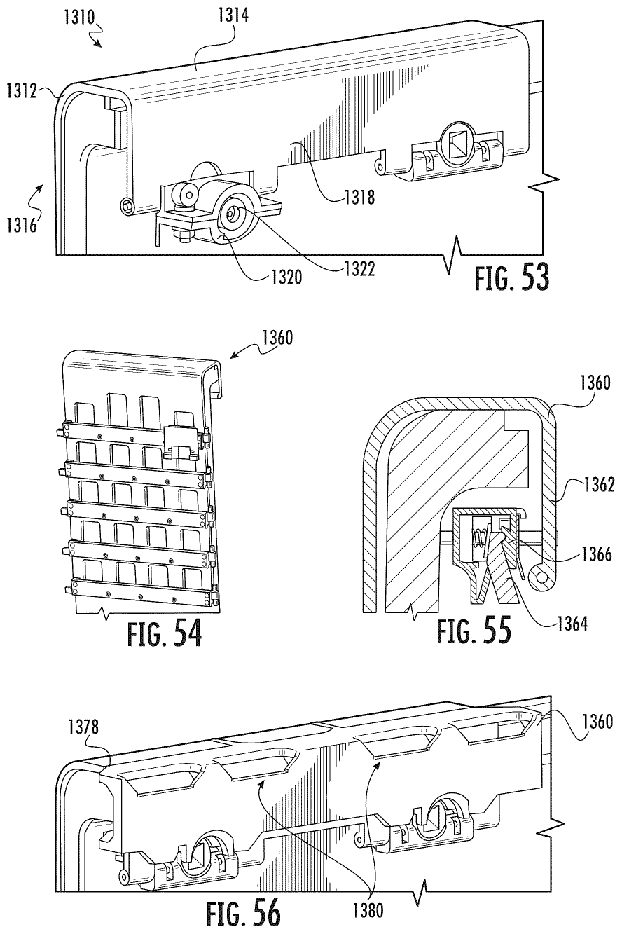

Referring to FIG. 53, various aspects of hanging tool support device 1310 are shown. Hanging tool support device 1310 is substantially the same as hanging tool support device 110, hanging tool support device 310, hanging tool support device 410, hanging tool support device 510, hanging tool support device 610, hanging tool support device 710, hanging tool support device 1210 or hanging tool support device 1260 except for the differences discussed herein.

Hanging tool support device 1310 includes wall 1312 that extends around the wall to which hanging tool support device 1310 is coupled. Wall 1312 includes upper portion 1314, front portion 1316, and rear portion 1318.

Securing element 1320 is coupled to rear portion 1318. Securing element 1320 includes a fastener 1322 to secure hanging tool support device 1310 to the wall hanging tool support device 1310 is coupled to. In various embodiments fastener 1322 is threaded, such as helically threaded. In various embodiments, securing element 1320 is tightened and loosened via pliers and/or fingers of a user.

Referring to FIG. 54, various aspects of hanging tool support device 1360 are shown. Hanging tool support device 1360 is substantially the same as hanging tool support device 110, hanging tool support device 310, hanging tool support device 410, hanging tool support device 510, hanging tool support device 610, hanging tool support device 710, hanging tool support device 1210, hanging tool support device 1260 or hanging tool support device 1310 except for the differences discussed herein.

Hanging tool support device 1360 includes wall 1362, securing element 1364 coupled to a rear portion of wall 1362, and fastener 1366 slidably coupled to securing element 1364 to secure hanging tool support device 1360 to the wall that hanging tool support device 1360 is coupled to. In various embodiments fastener 1366 is threaded, such as helically threaded. Hanging tool support device 1360 includes plate 1378 coupled to a rear of hanging tool support device 1360, and plate 1378 defines one or more female couplers 1380.

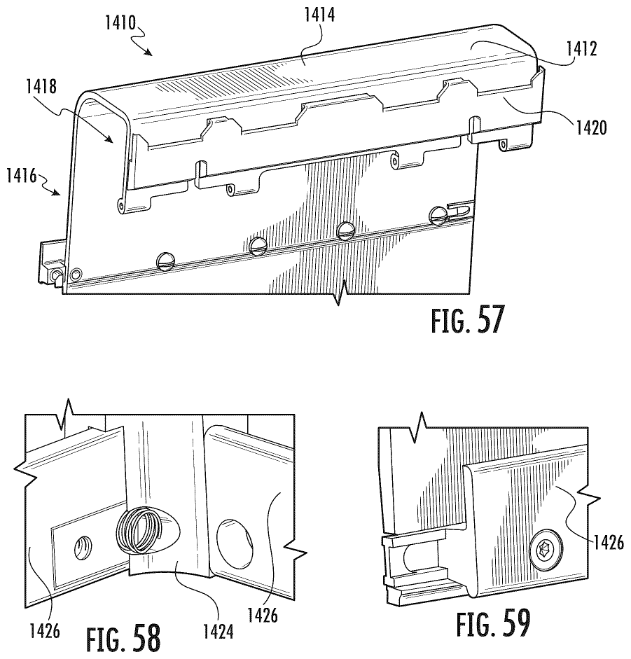

Referring to FIGS. 57-63, various aspects of hanging tool support device 1410 are shown. Hanging tool support device 1410 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310 or hanging tool support device 1360 except for the differences discussed herein.

Hanging tool support device 1410 includes wall 1412 that engages with a wall (e.g., a utility bucket wall). Wall 1412 includes upper portion 1414, front portion 1416, and rear portion 1418. Hanging tool support device 1410 includes couplers 1420 extending from rear portion 1418. In various embodiments rails 1426 are detachably coupled to corner element 1424 (FIG. 58). In various embodiments, hanging tool support device 1410 is formed from extruded plastic.

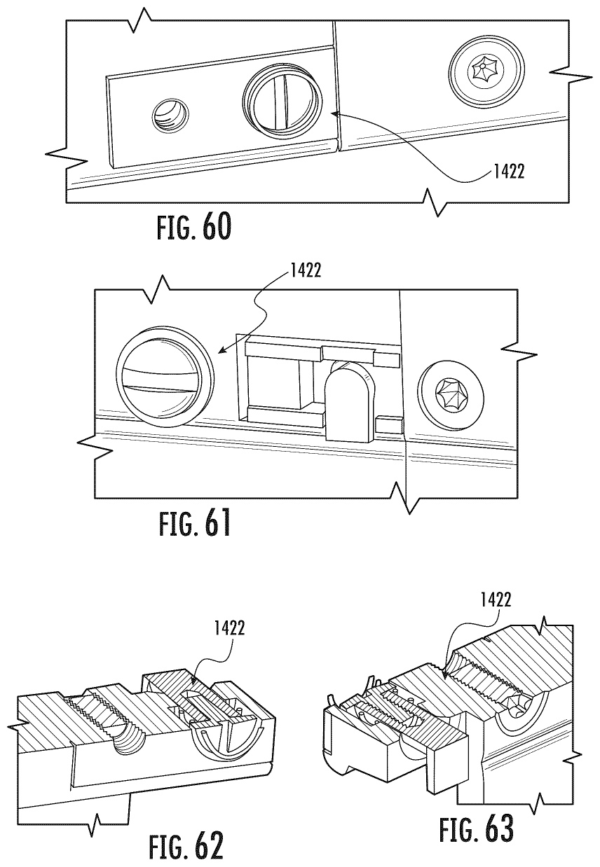

Referring to FIGS. 60-63, in various embodiments hanging tool support device 1410 includes securing element 1422 that secures hanging tool support device 1410 to a wall, such as of a utility bucket.

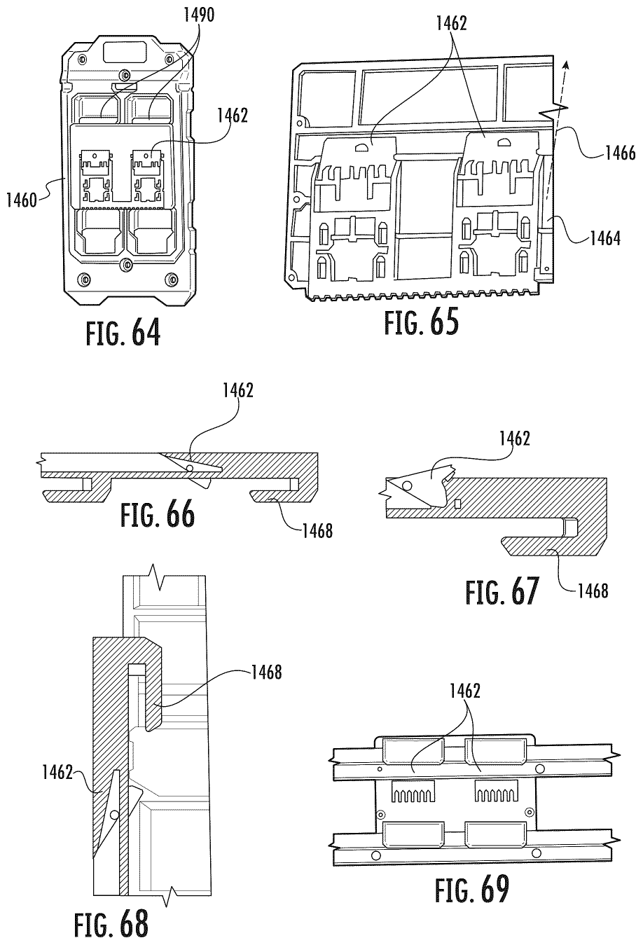

Referring to FIGS. 64-69, various aspects of board 1460 are shown. Board 1460 is configured to couple to female couplers 1490. Board 1460 includes locker 1462, button 1464, and arms 1468. Arms 1468 slidably engage with female couplers 1490, and locker 1462 secures board 1460 to female couplers 1490 by preventing board 1460 from sliding (e.g., upward) with respect to female couplers 1490. To decouple board 1460 from female couplers 1490, a user moves button 1464 in direction 1466, thereby moving locker 1462 from the locked position (e.g., FIG. 66) to the unlocked position (e.g., FIG. 67). When locker 1462 is in the unlocked position, board 1460 can slide with respect to female couplers 1490, and thus disengage board 1460 from female couplers 1490. In various embodiments, locker 1462 is spring biased to the locked position.

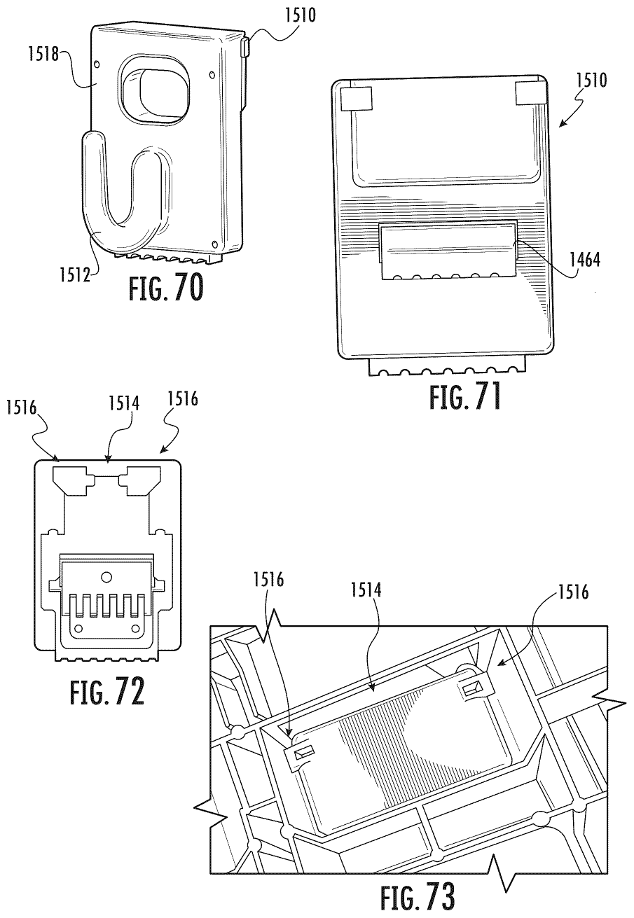

Referring to FIGS. 70-73, various aspects of support element 1510 are shown. Support element 1510 includes hook 1512, coupler 1514, ears 1516 slidably engaged with coupler 1514, and button 1518. Ears 1516 secure support element 1510 to female couplers (e.g., female couplers 1490) by preventing support element 1510 from sliding (e.g., upward) with respect to the female coupler. To decouple support element 1510 from a female coupler, a user moves button 1518, which causes ears 1516 to slide towards each other, thereby permitting support element 1510 to slide with respect to female couplers, and thus disengage support element 1510 from the female couplers. In various embodiments, ears 1516 are spring biased away from each other.

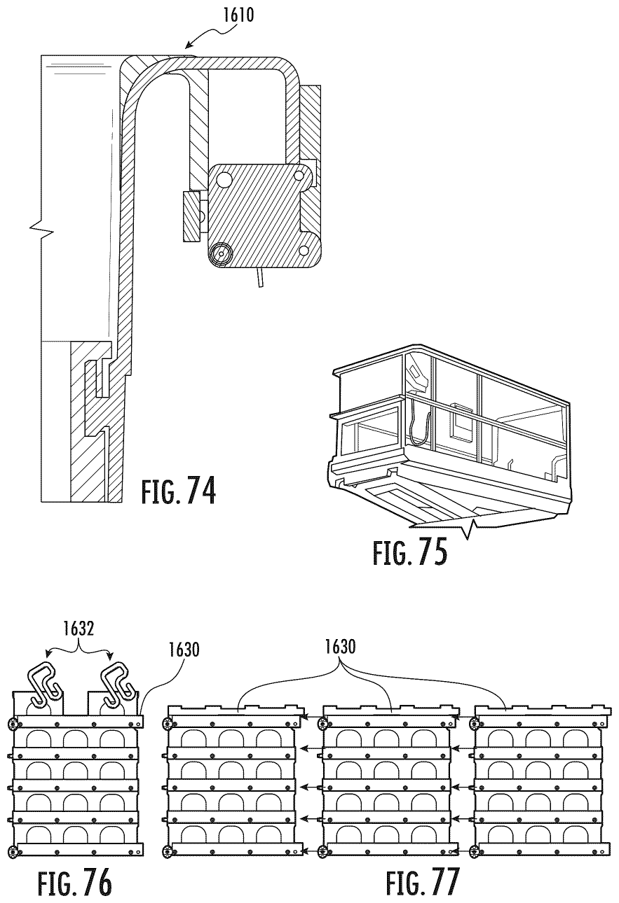

Referring to FIGS. 74-75, various aspects of hanging tool support device 1610 are shown. Hanging tool support device 1610 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360 or hanging tool support device 1410 except for the differences discussed herein. In particular, hanging tool support device 1610 includes a narrower space between the front and rear walls compared to other hanging tool support devices described herein, such as hanging tool support device 110, to facilitate hanging tool support device 1610 more securely engaging with other walls, such as walls of a lifting device such as the scissor lift shown in FIG. 75.

Referring to FIGS. 76-77, various aspects of boards 1630 are shown. Boards 1630 are substantially the same as board 1460 except for the differences discussed herein. Boards 1630 are coupled to walls, such as walls of a utility bucket, via one or more hooks 1632 that engage with the wall of the utility bucket.

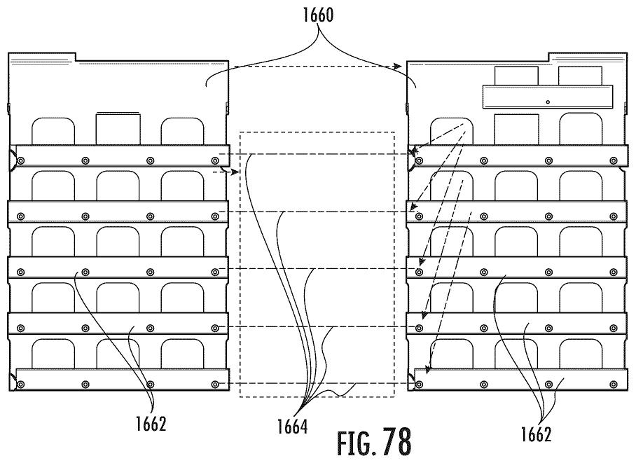

Referring to FIG. 78, various aspects of boards 1660 are shown. Boards 1660 is substantially the same as board 1460 or board 1630 except for the differences discussed herein. Boards 1660 include extenders 1664 that detachably couple with rails 1662 of boards 1660, thereby engaging, such as rigidly engaging, different boards 1660. In this way, boards 1660 are easily expandable to varying lengths depending on the size of the wall that boards 1660 are being affixed to.

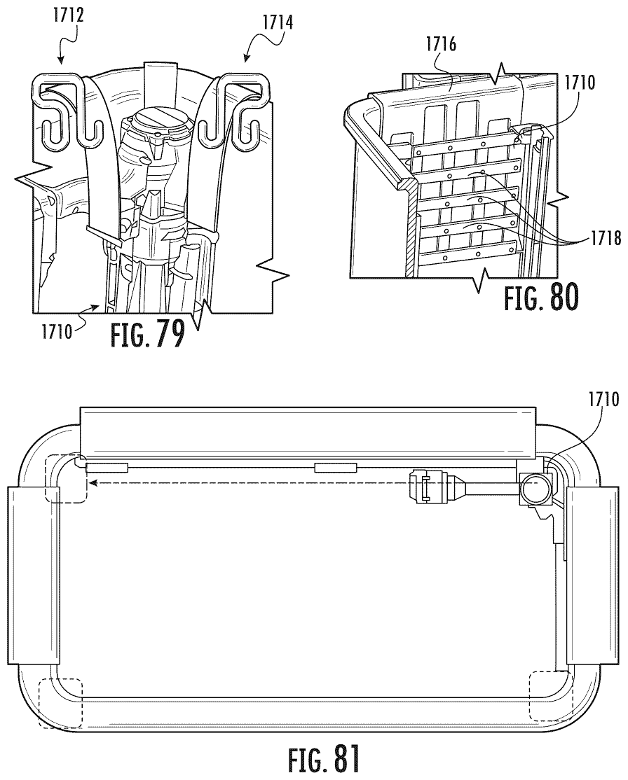

Referring to FIGS. 79-81, various aspects of mounting element 1710 are shown. Mounting element 1710 is configured to engage within walls of an object, such as at the corner of a utility bucket. In various embodiments, mounting element 1710 is coupled to the utility bucket via hooks 1712, 1714. Mounting element 1710 is configured to detachably engage with board 1716, which includes rails 1718. Rails 1718 are configured to detachably engage with various objects, such as support elements described herein. In various embodiments, mounting element 1710 can be mounted to any of the corners shown in FIG. 81.

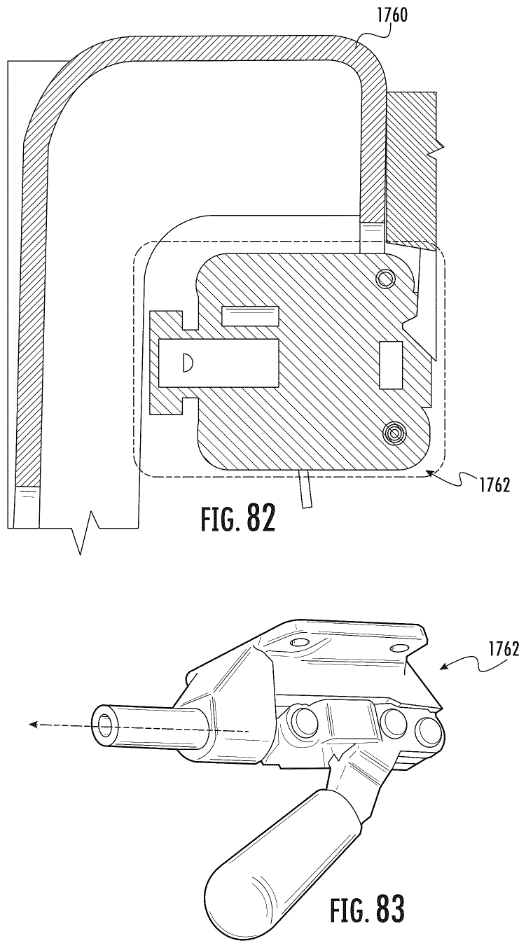

Referring to FIGS. 82-83, various aspects of hanging tool support device 1760 are shown. Hanging tool support device 1760 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410 or hanging tool support device 1610 except for the differences discussed herein. In particular, hanging tool support device 1760 includes a cam 1762 configured to secure the hanging tool support device 1760 against an object, such as a wall of a utility bucket.

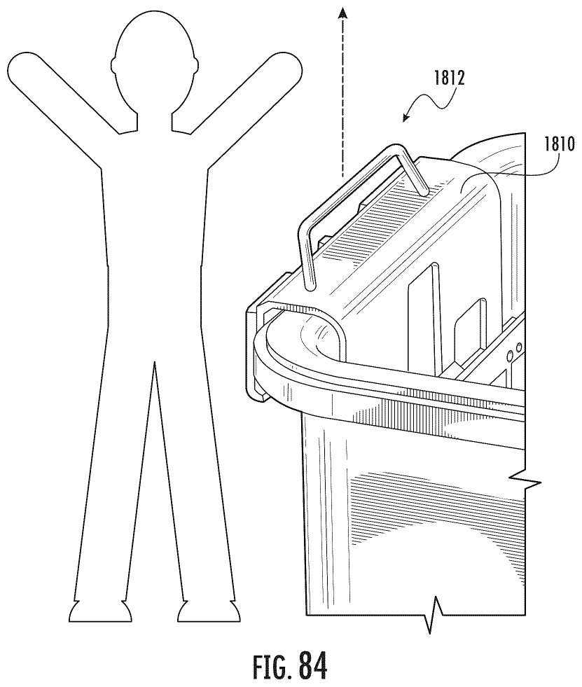

Referring to FIG. 84, various aspects of hanging tool support device 1810 are shown. Hanging tool support device 1810 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, or hanging tool support device 1610 except for the differences discussed herein. In particular, hanging tool support device 1810 includes a handle 1812 to facilitate a user lifting hanging tool support device 1810.

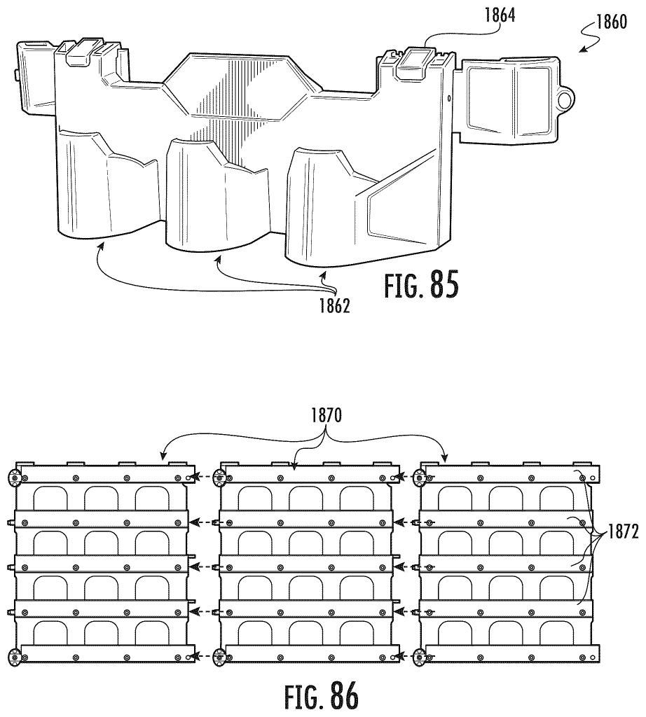

Referring to FIGS. 85-86, various aspects of support element 1860 are shown. Support element 1860 is substantially the same as support element 1510 except for the differences discussed herein.

Support element 1860 includes containers 1862 configured to receive and store objects (e.g., tools, fasteners). Support element 1860 includes clamp 1864, which is configured to secure support element 1860 to an object, such as rails 1872 of boards 1870. Alternatively, support element 1860 can be detachably coupled to a vertical support element, such as a vertical rail on a corner of a box, such as a modular storage unit.

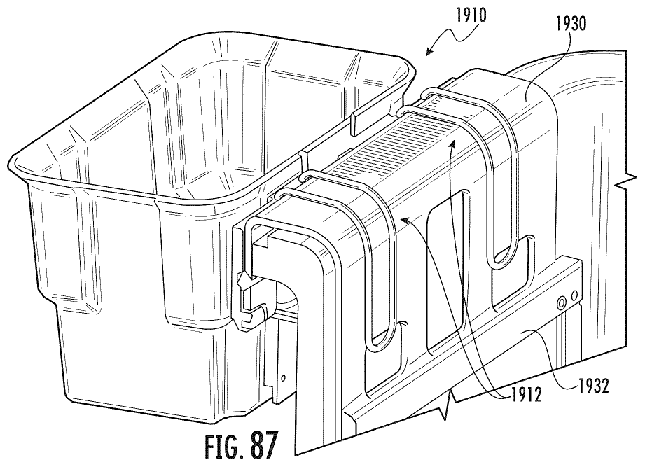

Referring to FIG. 87, various aspects of support element 1910 are shown. Support element 1910 is substantially the same as support element 1510 or support element 1860 except for the differences discussed herein.

In particular, support element 1910 includes arms 1912 that engage over board 1930 to engage in the space under board 1930 and behind rails 1932.

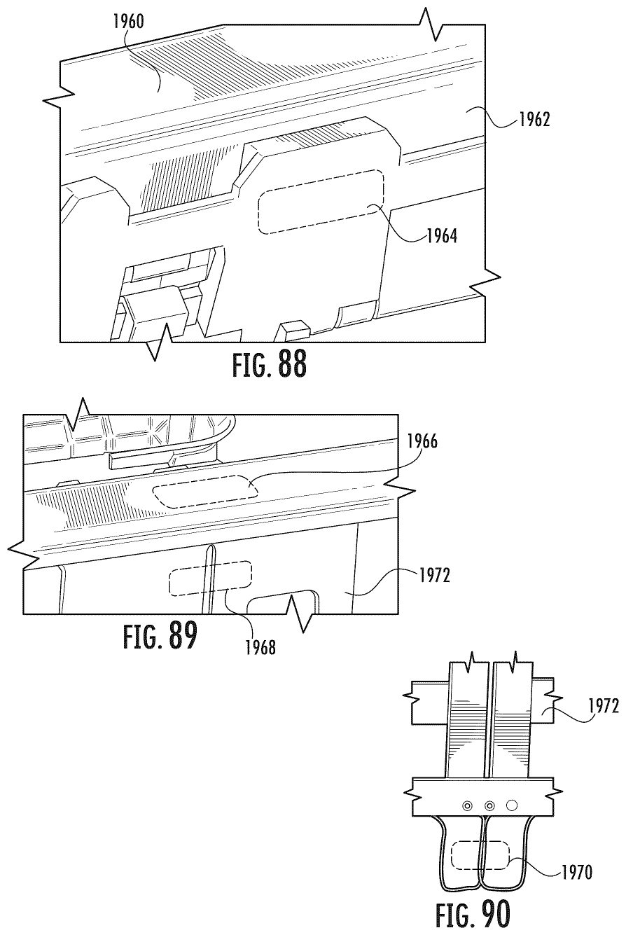

Referring to FIGS. 88-90, various aspects of hanging tool support device 1960 are shown. Hanging tool support device 1960 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610 or hanging tool support device 1810 except for the differences discussed herein.

In particular, hanging tool support device 1960 includes multiple locations to which locking mechanisms can be coupled to secure other objects, such as support elements. In various embodiments, hanging tool support device 1960 includes first location 1964 on rear wall 1962, second location 1966 on top of hanging tool support device 1960, third location 1968 on the front wall 1972 of hanging tool support device 1960, and/or fourth location 1970 below the rails on the front wall 1972 of hanging tool support device 1960.

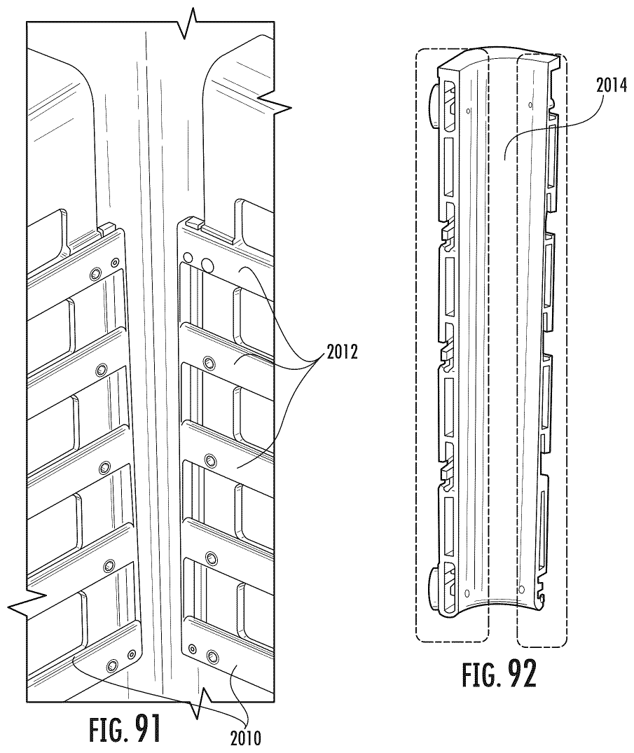

Referring to FIGS. 91-92, various aspects of hanging tool support device 2010 are shown. Hanging tool support device 2010 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810 or hanging tool support device 1960 except for the differences discussed herein.

Hanging tool support device 2010 includes rails 2012 that detachably couple with corner element 2014, such as rigidly detachably couple with corner element 2014. In various embodiments, corner element 2014 is configured to be disposed in a corner of a utility bucket.

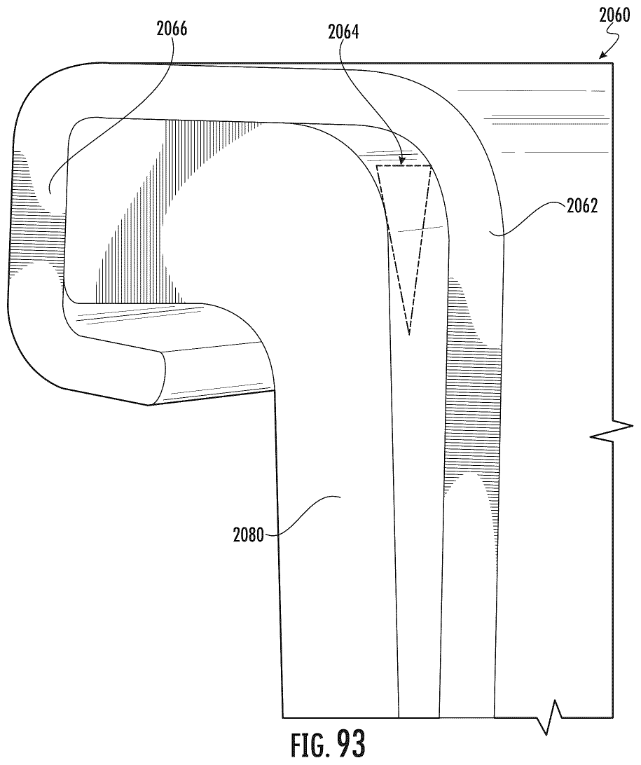

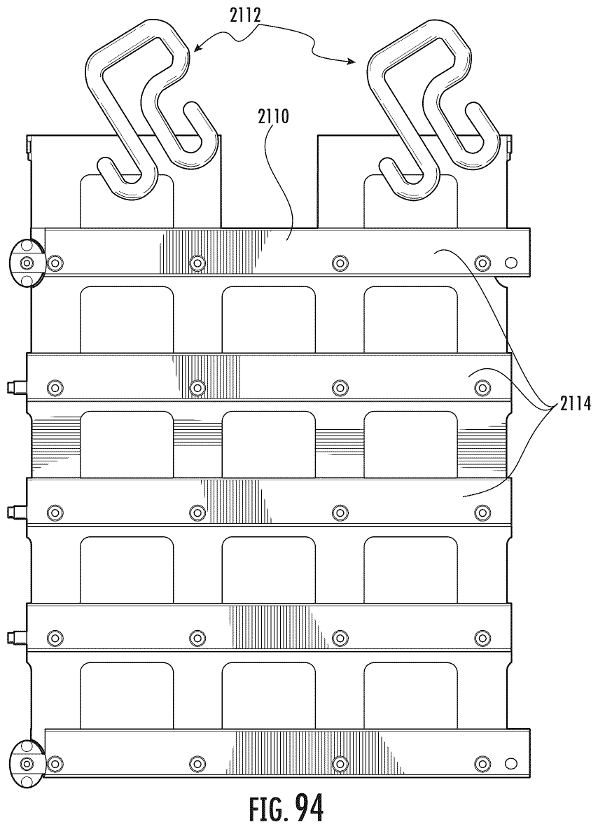

Referring to FIG. 93, various aspects of hanging tool support device 2060 are shown. Hanging tool support device 2060 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810, hanging tool support device 1960 or hanging tool support device 2010 except for the differences discussed herein.

In particular, hanging tool support device 2060 includes wedge 2064 to secure hanging tool support device 2060 against utility bucket wall 2080. In various embodiments, wedge 2064 is inserted between front wall 2062 and/or rails to bias rear wall 2066 towards utility bucket wall 2080 and thereby prevent hanging tool support device 2060 from being removed from the respective utility bucket until the wedge 2064 is removed.

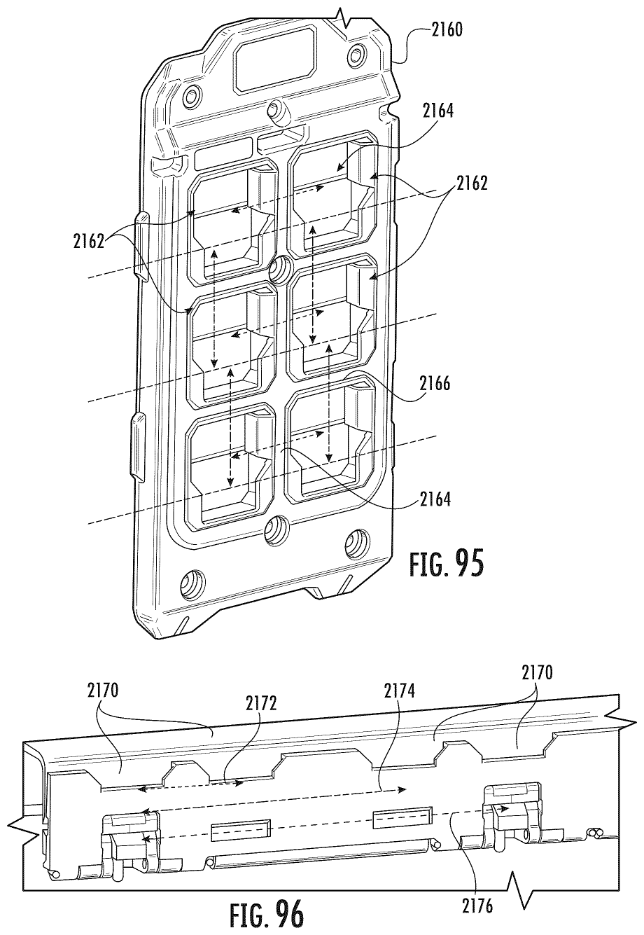

Referring to FIG. 95, various aspects of board 2110 are shown. Board 2110 is substantially the same as board 1460, board 1630 or board 1660 except for the differences discussed herein. In particular, board 2110 includes hooks 2112 to couple boards 2110 to an object, such as wall. Board 2110 includes rails 2114, which in various embodiments extend horizontally and are configure to support objects, such as support elements described herein.

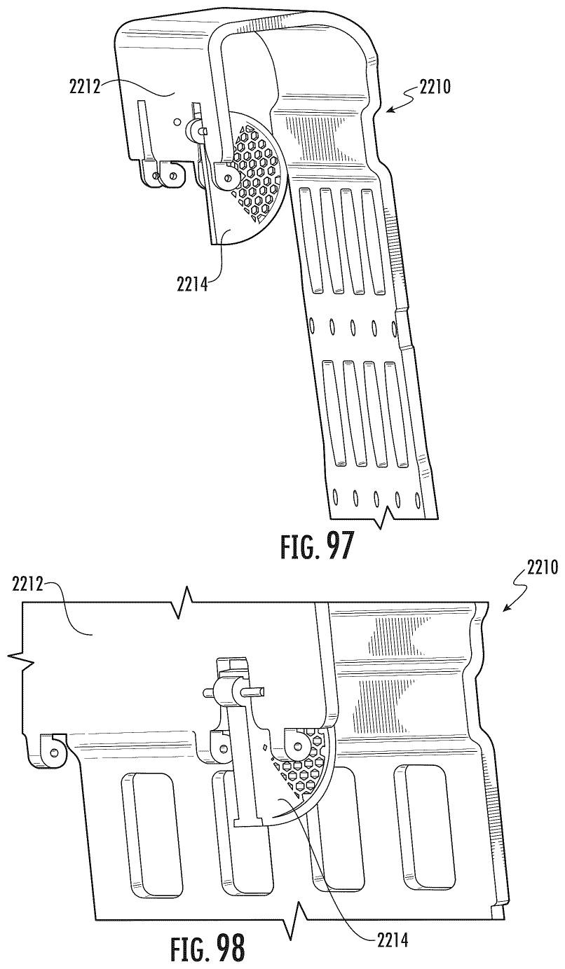

Referring to FIGS. 96-97, various aspects of board 2160 are shown. Board 2160 is substantially the same as board 1460, board 1630, board 1660 or board 2110 except for the differences discussed herein.

In particular, board 2160 includes female couplers 2162. In various embodiments, female couplers 2162 are spaced distance 2164, which is 102.5 mm, apart from each other horizontally, and female couplers 2162 are spaced distance 2166, which is 102.5 mm, apart from each other vertically.

In various embodiments, female couplers 2170 on rear of board 2160 are spaced distance 2172, which is 102.5 mm, apart from each other horizontally, and are spaced distance 2174, which is 254.8 mm, apart from female couplers 2170 that are two female couplers 2170 apart, and are spaced distance 2176, which is 357.3 mm, apart from female couplers 2170 that are three female couplers 2170 apart.

Referring to FIGS. 97-98, various aspects of hanging tool support device 2210 are shown. Hanging tool support device 2210 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810, hanging tool support device 1960, hanging tool support device 2010 or hanging tool support device 2060 except for the differences discussed herein.

In particular, locking element 2214 is pivotally coupled to rear wall 2212 and locking element 2214 engages against a rear wall of an object that hanging tool support device 2210 is being coupled to. In various embodiments, locking element 2214 is configured to be compressible to facilitate hanging tool support device 2210 being tightly to a utility bucket.

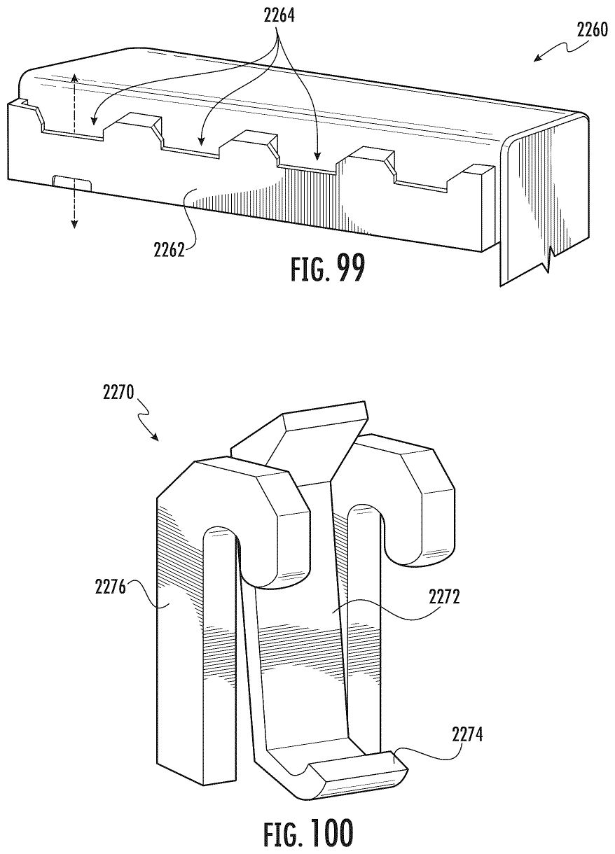

Referring to FIGS. 99-100, various aspects of hanging tool support device 2260 are shown. Hanging tool support device 2260 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810, hanging tool support device 1960, hanging tool support device 2010, hanging tool support device 2060 or hanging tool support device 2210 except for the differences discussed herein.

Hanging tool support device 2260 includes rear wall 2262 that includes couplers 2264. Support element 2270 is detachably coupled to couplers 2264, such as via hook 2274 extending through couplers 2264 and against rear wall 2262. Support element 2270 includes base 2276 and arm 2272 pivotally coupled to base 2276.

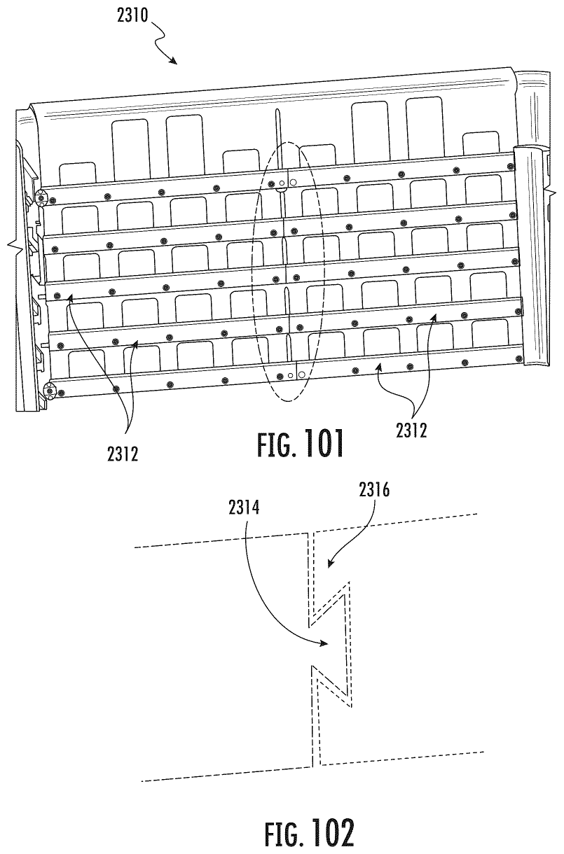

Referring to FIGS. 101-102, various aspects of hanging tool support device 2310 are shown. Hanging tool support device 2310 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810, hanging tool support device 1960, hanging tool support device 2010, hanging tool support device 2060, hanging tool support device 2210 or hanging tool support device 2260 except for the differences discussed herein.

Hanging tool support device 2310 detachably couples with other hanging tool support device 2310 via rails 2312 having dovetailed engagements with each other (see FIG. 102), such as a male dovetail 2314 in one rail 2312 and a female dovetail 2316 in a corresponding rail 2312.

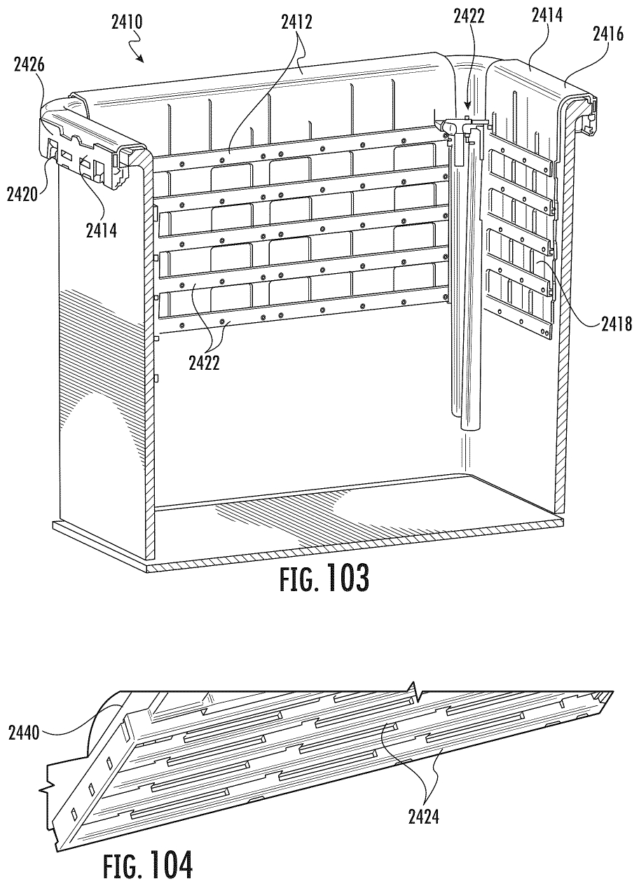

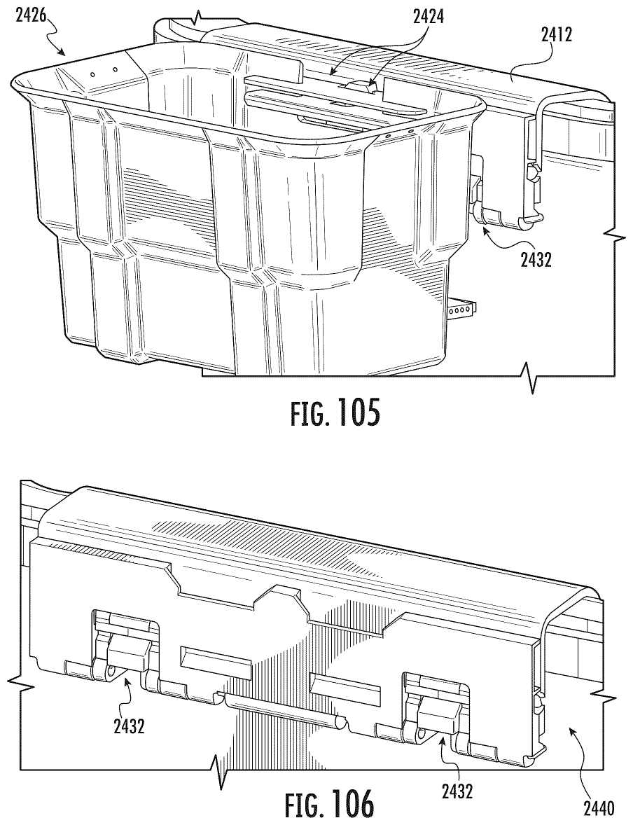

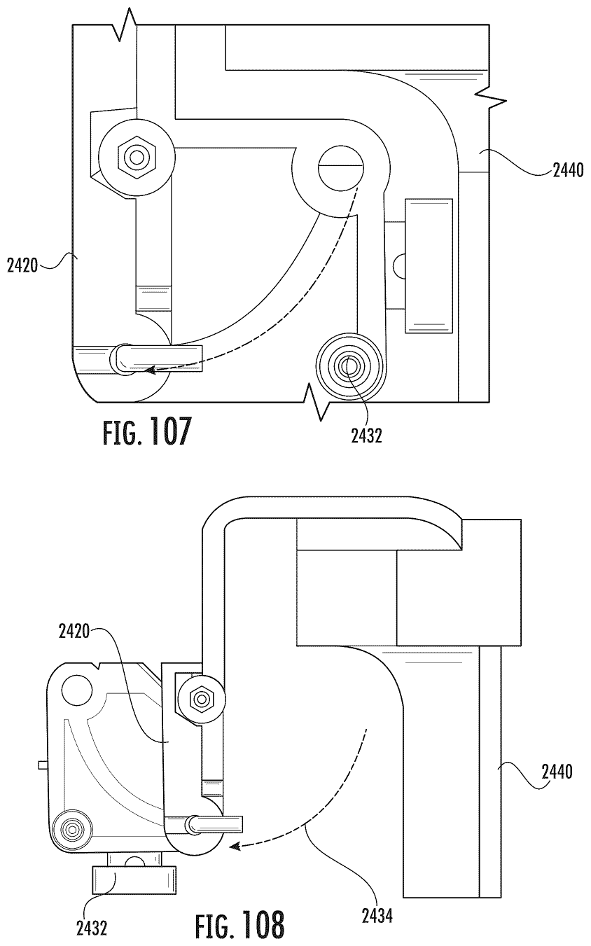

Referring to FIGS. 103-108, various aspects of hanging tool support device 2410 are shown. Hanging tool support device 2410 is substantially the same as hanging tool support device 110, hanging tool support device 310, hanging tool support device 410, hanging tool support device 510, hanging tool support device 610, hanging tool support device 710, hanging tool support device 1210, hanging tool support device 1260, hanging tool support device 1310, hanging tool support device 1360, hanging tool support device 1410, hanging tool support device 1610, hanging tool support device 1810, hanging tool support device 1960, hanging tool support device 2010, hanging tool support device 2060, hanging tool support device 2210, hanging tool support device 2260 or hanging tool support device 2310 except for the differences discussed herein.

Hanging tool support device 2310 includes boards 2412 and boards 2414 engaged against a utility bucket 2440. In various embodiments boards 2412 are approximately 50% larger (e.g., wider) than boards 2414.

Boards 2414 includes upper portion 2416, front portion 2418 on the inside of utility bucket 2440, and rear portion 2420 on the outside of utility bucket 2440. In various embodiments, hanging tool support device 2310 includes more than four rails 2424, such as five rails 2424. In various embodiments, corner element 2422 detachably couples a board 2412 to a board 2414, thereby placing rails 2424 of boards 2412, 2414 proximate each other. In various embodiments, rails 2424 are disposed a distance from utility bucket 2440, thereby permitting objects to be placed (e.g., stored) between rails 2424 and utility bucket 2440 and/or permitting debris to fall through and not build up against the rails 2424.

Boards 2412, 2414 include female couplers 2426, such as outside utility bucket 2440. A support element is configured to detachably couple to female couplers 2426. Boards 2412 and/or boards 2414 include clamp 2432 to secure boards 2412 and/or boards 2414 against utility bucket 2440. Clamp 2432 pivots in direction 2434 away from utility bucket 2440 to detach boards 2412 and/or boards 2414 from utility bucket 2440.

In various embodiments, clamp 2432 rotates about the top left corner of clamp 2432. This positioning of the rotational axis of clamp 2432 permits clamp 2432 to be larger, and thus stronger, and thus have a more secure fit with the utility bucket.

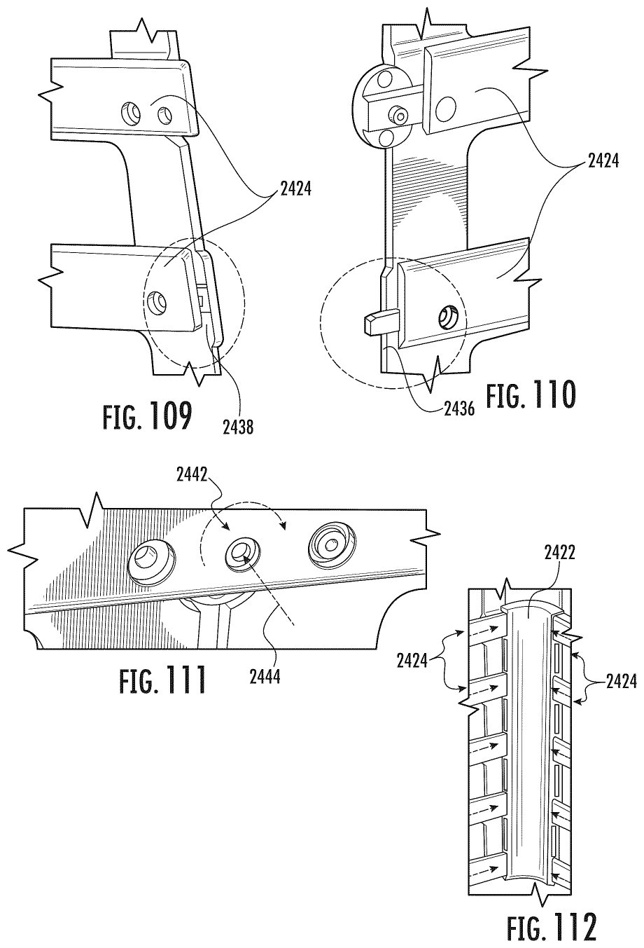

Referring to FIGS. 109-111, in various embodiments rails 2424 include projections 2436 and recesses 2438. The recesses 2438 are configured to receive the projections 2436 to facilitate laterally coupling rails 2424 together. Pin 2442 secures rails 2424 together once coupled. To decouple rails 2424, pin 2442 is pushed in direction 2444 and rotated clockwise, thereby permitting rails 2424 to be decoupled. Referring to FIG. 112, corner element 2422 receives rails 2424 detachably rigidly couples to rails 2424.

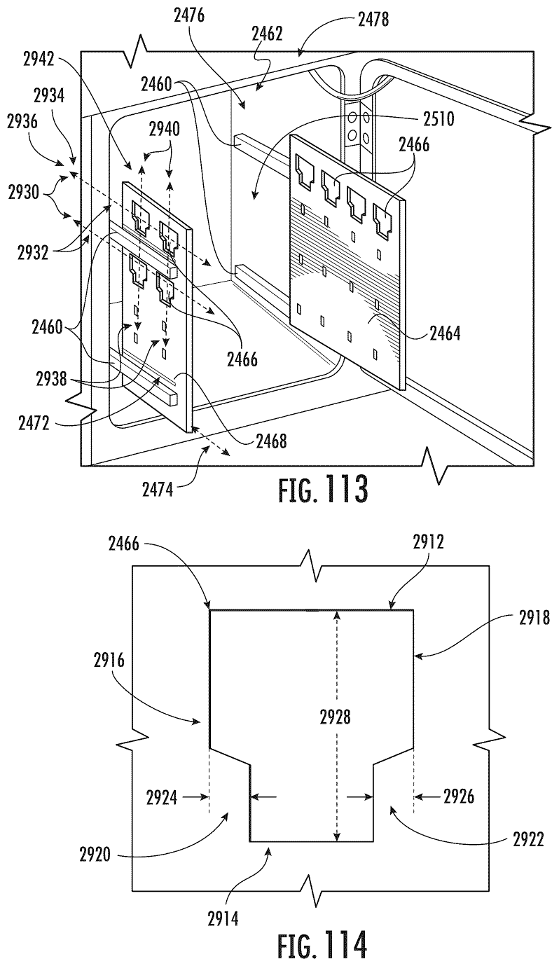

Referring to FIGS. 113-114, various aspects of a storage mechanism are shown. Tool support device 2462 includes plate 2464, a plurality of coupling mechanisms 2472 coupled to the plate 2464, and a plurality of coupling structures, shown as female couplers 2466, defined by plate 2464. The plurality of coupling mechanisms 2472 are configured to detachably couple with first rails 2460 coupled to an interior wall 2476 of a motor vehicle 2478 (see FIG. 113), and the plurality of coupling mechanisms 2472 are configured to detachably couple with second rails of a support structure hanging from a wall of a power utility bucket (e.g., see panels 160 of hanging tool support device 110). Each of the plurality of female couplers 2466 include an upper wall 2912, a first side wall 2916, a second side wall 2918 opposite the first side wall 2916, a lower wall 2914 opposite the upper wall 2912, a first rib 2920 extending from each of the lower wall 2914 and the first side wall 2916, and a second rib 2918 extending from each of the lower wall 2914 and the second side wall 2918.

In use, wall plates 2464, 2468 are configured to be coupled to rails 2460, decoupled from rails 2460, and detachably coupled to support structures hanging from a wall of a power utility bucket. Each of female couplers 2466 are configured to detachably engage with other objects, such as storage units with corresponding male couplers that will engage with the female couplers. In use, wall plates 2464, 2468 are slid out from vehicle storage compartment 2510, an object is coupled to one of wall plates 2464, 2468, and then wall plates 2464, 2468 are slid back into compartment 2510. In this way, objects can be securely stored within compartment 2510 and easily accessed.

In various embodiments, the plurality of female couplers 2466 are configured to detachably couple to a first male coupling structure (e.g., see male coupler 810 in FIG. 17) coupled to an object. In various embodiments, the plurality of female couplers 2466 are configured to detachably couple to a plurality of male coupling structures coupled to a plurality of objects, such as hand tools. In this way, moving plates 2464, 2468 between objects, such as a wall of a motor vehicle and a support structure hanging from a power utility bucket, facilitates a user moving multiple tools and/or objects between the transportation vehicle (e.g., the motor vehicle) and the working environment (e.g., the power utility bucket).

In various embodiments, for each of the plurality of female couplers 2466, the first rib 2920 extends a first horizontal distance 2924 from the first side wall 2916 towards the second side wall 2918, and the first rib 2920 extends a first vertical distance 2928 from the lower wall 2914 towards the upper wall 2912, and the first vertical distance 2928 is greater than the first horizontal distance 2924. In various embodiments, the first vertical distance 2928 is at least twice as far as the first horizontal distance 2924.

In various embodiments, for each of the plurality of female couplers 2466, the second rib 2922 extends a second horizontal distance 2926 from the second side wall 2918 towards the first side wall 2916, and the first vertical distance 2928 is greater than the second horizontal distance 2926. In various embodiments, the second horizontal distance 2926 equals the first horizontal distance 2924.

In various embodiments, the plurality of female couplers 2466 include a first row 2934 of female couplers 2466 arranged along a first horizontal axis 2936, the plate 2464 slides along a sliding axis 2474 with respect to the wall 2476 of the motor vehicle 2478, and the first horizontal axis 2936 is parallel to the sliding axis 2474. In various embodiments, the plurality of female couplers 2466 include a first column 2942 of female couplers 2466 arranged along a first vertical axis 2944, and the first vertical axis 2944 is perpendicular to the sliding axis 2474.

In various embodiments, the plurality of female couplers 2466 include a plurality of rows 2930 of female couplers 2466 arranged along horizontal axes 2932, and the plate 2464 slides along a sliding axis 2474 with respect to the wall 2476 of the motor vehicle 2478, and the horizontal axes 2932 are parallel to the sliding axis 2474. In various embodiments, the plurality of female couplers 2466 include a plurality of columns 2938 of female couplers 2466 arranged along vertical axes 2940, and the vertical axes 2940 are perpendicular to the sliding axis 2474.

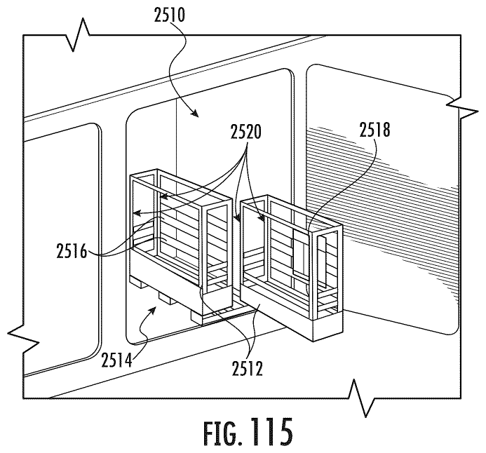

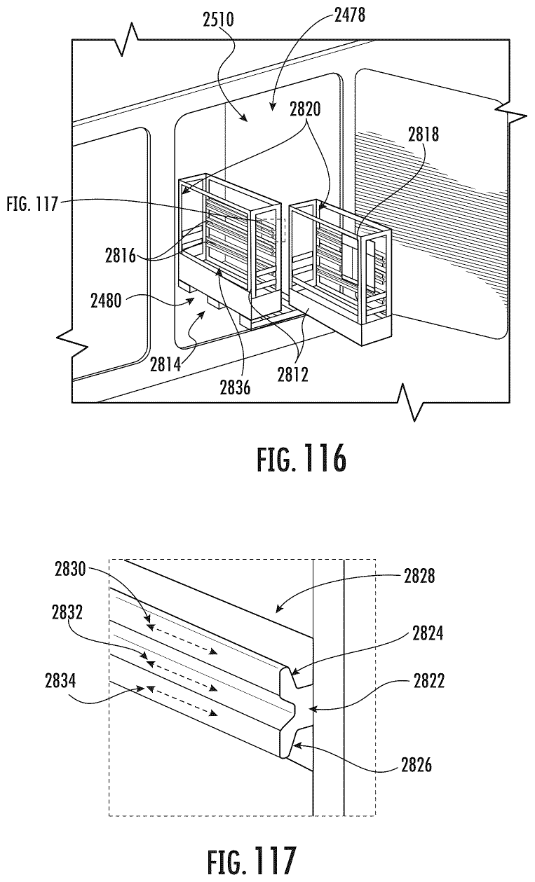

Referring to FIG. 115, various aspects of containers 2512 are shown. In various embodiments, containers 2512 slidably engage with base 2514, which is within compartment 2510. Containers 2512 include one or more rails 2516, such as horizontally extending from arms 2520 extending upward from base 2514, the rails 2516 configured to engage with support elements 2518.

Referring to FIGS. 116-117, various aspects of containers 2812 are shown. Containers 2812 are functionally and structurally the same as containers 2512 except as otherwise described.

In various embodiments, containers 2812 slidably engage with base 2814, which is within compartment 2510. Containers 2812 include one or more arms 2820 extending upward from base 2814. One or more rails 2816 extending laterally between arms 2820.

Container 2812 includes a base 2814 configured to be slidably coupled to a horizontal support surface 2480 of a motor vehicle 2478, a first plurality of arms 2820 extending upward from the base 2814, a second plurality of arms, shown as rails 2816, extending horizontally between the plurality of arms 2820. Each rail 2816 of the plurality of rails 2816 includes a body 2822 extending between and coupled to the arms 2820, an upper projection 2824 extending upward and laterally from the body 2822, and a lower projection 2826 extending downward and laterally from the body 2822. The plurality of arms 2820 are configured to detachably engage with support elements, such as support element 2818 that are coupled to objects (e.g., hand tools, equipment), such as support element 910 (FIG. 20) and/or support element 960 (FIG. 24).

In various embodiments, for each of the plurality of rails 2816, the body 2822 extends laterally along a first horizontal axis 2830, and the upper projection 2824 extends laterally along a second horizontal axis 2832 parallel to the first horizontal axis 2830. In various embodiments, for each of the plurality of rails 2816, the body 2822 extends inwardly from the plurality of rails 2816 into an internal compartment 2836 of the container 2812. In various embodiments, for each of the plurality of rails 2816, the upper projection 2824 extends inwardly from the body 2822 into an internal compartment 2836 of the container 2812. In various embodiments, for each of the plurality of rails 2816, the lower projection 2826 extends inwardly from the body 2822 into the internal compartment 2836 of the container 2812.

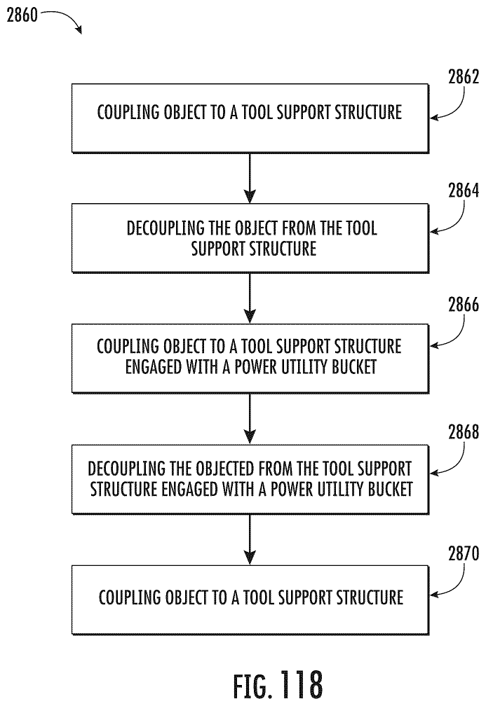

Referring to FIG. 118, various aspects of a method 2860 of using one or more embodiments described herein are provided. Starting at step 2862, an object including a modular support element (e.g., male coupler 810 of FIG. 17, coupling mechanisms 2472 of FIG. 113) is coupled to a first tool support structure (e.g., containers 2812) in a motor vehicle. As a first non-limiting example, plate 2464 in FIG. 113 may be coupled to a motor vehicle, such as to rails 2460 coupled to a motor vehicle. As a second non-limiting example, support element 2818 is coupled to containers 2812 in a motor vehicle (see FIG. 116). In various embodiments, the object coupled to the first tool support structure in a motor vehicle includes a container configured to receive a plurality of pieces of equipment (e.g., support element 2518 in FIG. 115 includes a container configured to receive a plurality of pieces of equipment, such as fasteners).

Next, the object is decoupled from the first tool support structure in the motor vehicle at step 2864, and then coupled to a second tool support structure engaged with a power utility bucket, such as a tool support structure engaged with a wall of a power utility bucket at step 2866. As one non-limiting example, the object could be coupled to hanging tool support device 110. At step 2868, the object is decoupled from the second tool support structure that is engaged with a wall of a power utility bucket, and at step 2870 the object is coupled to the first tool support structure in the motor vehicle. Applicant has observed that providing the ability for users to quickly move single objects, such as hand tools, or collections of objects, such as devices coupled to plate 2464 that are being moved between a motor vehicle and a power utility bucket, facilitates how quickly users can deploy in the field when they arrive at a working location.

In various exemplary methods, the method includes coupling a plurality of objects (e.g., plates 2464, support elements 2818, tools including modular support elements, such as male couplers 810), including the first object, to the first tool support structure (e.g., rails 2460, containers 2812), each of the plurality of objects including at least one modular support element (e.g., male couplers 810) identical to the first modular support element of the first object, and the method further includes coupling the plurality of objects to the second support structure, such as hanging tool support device 110.

In various exemplary methods, the first tool support structure includes a female coupler (e.g., female pocket 1130, female coupler 1380, female coupler 2466) that engages with the at least one modular support elements (e.g., male coupler 810 of FIG. 17, coupling mechanisms 2472 of FIG. 113). In various exemplary methods, the first tool support structure includes a plurality of rails (e.g., rails 2816) extending horizontally, each rail 2816 of the plurality of rails 2816 including a body 2822, an upper projection 2824 extending upward and laterally from the body 2822, and a lower projection 2826 extending downward and laterally from the body 2822, the plurality of rails 2816 configured to detachably engage with the at least one modular support elements.

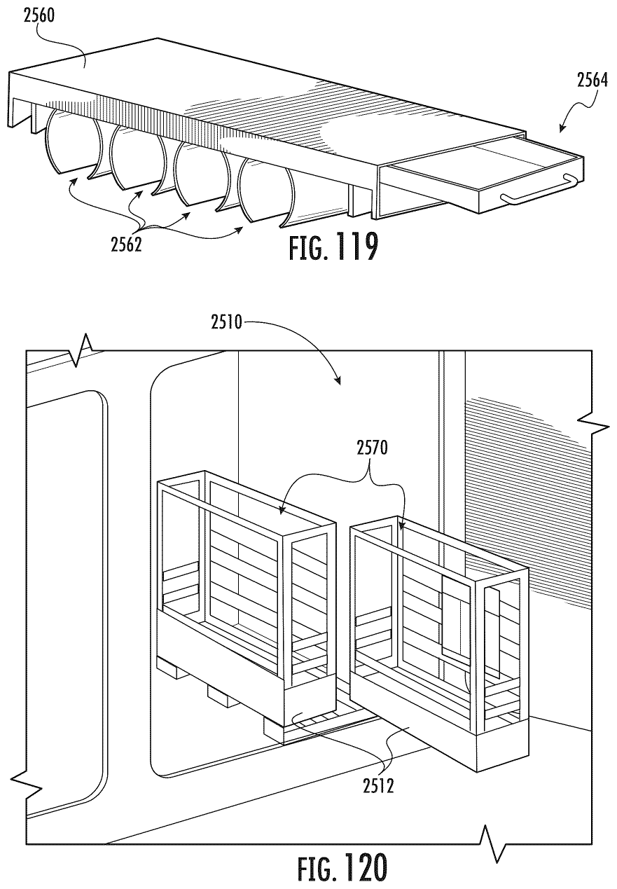

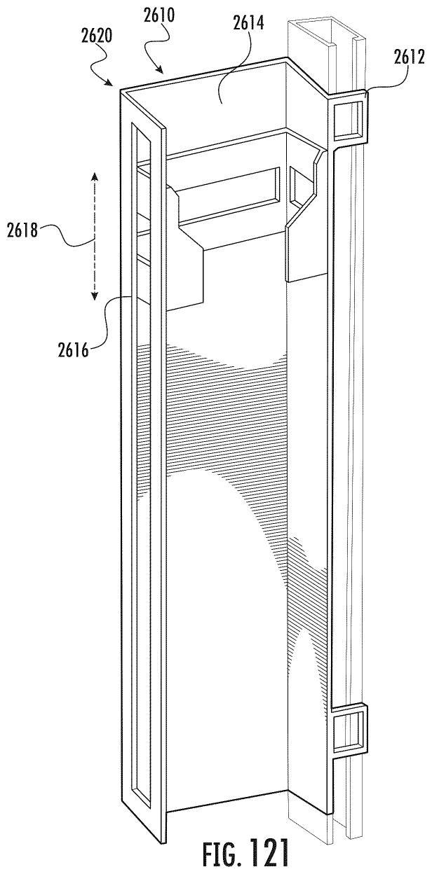

Referring to FIGS. 119-120, various aspects of containers 2512 are shown. In various embodiments, containers 2512 include support element 2560, which is configured to engage on and rest within top 2570 of container 2512. Support element 2560 includes one or more recesses 2562 configured to detachably engage and support objects, such as hand tools (e.g., hand drill), and a drawer 2564 slidably extendable from support element 2560.

Referring to FIG. 121, various aspects of support element 2620 are shown. In various embodiments, support element 2620 includes base 2610, which includes arm 2612 to secure base to an object, such as a wall. Support elements 2620 includes recess 2614 within which one or more cleats 2616 slide along axis 2618 with respect to base 2610. Cleats 2616 are configured to engage with objects, such as objects including male couplers that will engage with cleats 2616 similar to how the male couplers engage with cleat 2616.

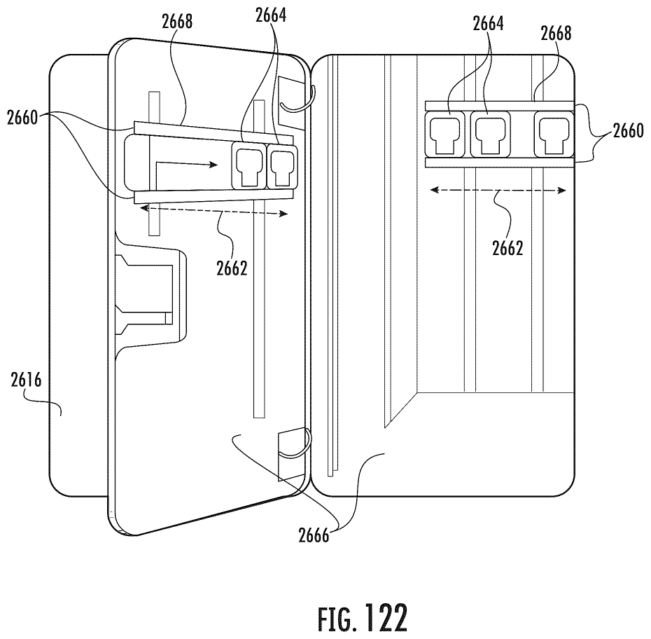

Referring to FIG. 122, various aspects of support element 2668 are shown. In various embodiments, support element 2668 includes arms 2660. Support element 2668 includes cleats 2664 that slide along axis 2662 with respect to arms 2660. Cleats 2664 are configured to engage with objects, such as objects including male couplers that will engage with cleats 2664 similar to how the male couplers engage with cleat 2664.

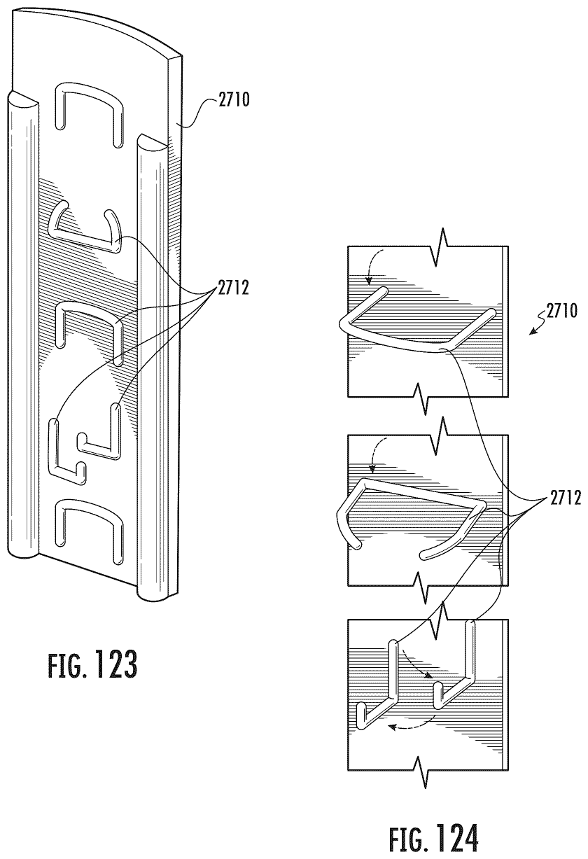

Referring to FIGS. 123-124, various aspects of support element 2710 are shown. Support element 2710 includes one or more hooks 2712. In various embodiments hooks 2712 actuate between being extended (e.g., FIG. 115) and retracted (e.g., FIG. 114), thereby permitting the user to decide which hooks 2712 are to be used and which should be stored until later.

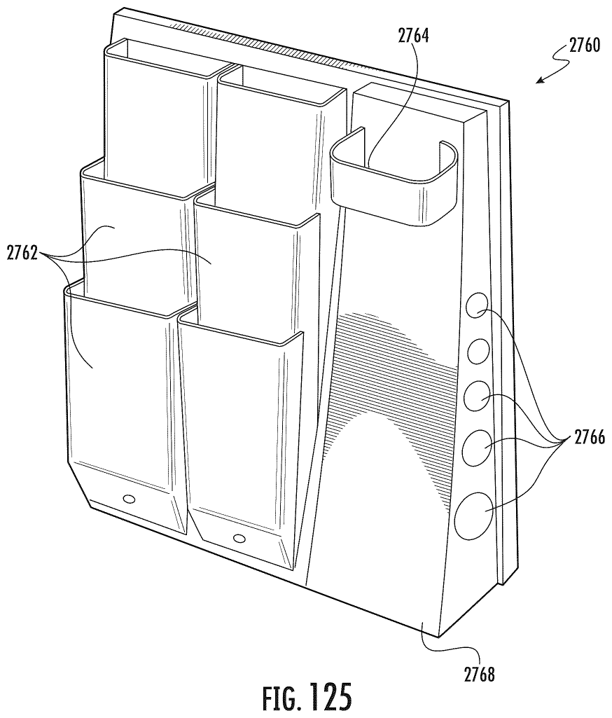

Referring to FIG. 125, various aspects of support element 2760 are shown. Support element 2760 includes one or more compartments 2762, and a loop 2764. In various embodiments, loop 2764 is configured to support an elongate object, such as a hammer. Support element 2760 includes base 2768, which defines one or more apertures 2766, which are configure to receive objects, such as drill bits and/or sockets of varying sizes.

In a specific embodiment, the coupling components, protrusions and latches described herein are compatible with the coupling mechanism(s) described in International Patent International Patent Publication No. WO/2017/191628, which is hereby incorporated by reference in its entirety.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A method of selectably supporting a first object within a utility bucket and a vehicle storage compartment comprising:
coupling the first object that comprises a first modular support element to a first tool support structure within a motor vehicle via engagement between the first modular support element and the first tool support structure, the first tool support structure comprising:
a base slidably coupled to a horizontal support surface of the motor vehicle;
a first plurality of arms extending upward from the base; and
a second plurality of arms extending horizontally between the first plurality of arms, the second plurality of arms configured to detachably engage with the first modular support element of the first object;
decoupling the first object from the first tool support structure; and
coupling the first object to a second tool support structure hanging from a wall of a power utility bucket via engagement between the first modular support element and the second tool support structure.

2. The method of claim 1, wherein the first object comprises a hand tool.

3. The method of claim 1, wherein the first object comprises a container configured to receive a plurality of pieces of equipment.

4. The method of claim 1, further comprising:
coupling a plurality of objects, including the first object, to the first tool support structure, each of the plurality of objects including at least one modular support element identical to the first modular support element; and
coupling the plurality of objects to the second tool support structure.

5. The method of claim 1, further comprising decoupling the object from the second tool support structure and recoupling the object to the first tool support structure.

6. The method of claim 5, wherein the first tool support structure comprises a female coupler that engages with the at least one modular support elements.

7. The method of claim 5, wherein the first tool support structure comprises a plurality of rails extending horizontally, each rail of the plurality of rails comprising a body, an upper projection extending upward and laterally from the body, and a lower projection extending downward and laterally from the body, the plurality of rails configured to detachably engage with the at least one modular support elements.

8. A tool support device configured to couple to a supporting wall, the tool support device comprising:
a plate;
a plurality of coupling mechanisms coupled to the plate, the plurality of coupling components configured to detachably couple with first rails coupled to a wall of a motor vehicle, and the plurality of coupling components configured to detachably couple with second rails of a support structure hanging from a wall of a power utility bucket; and
a plurality of coupling structures defined by the plate, each of the plurality of coupling structures comprising an upper wall, a first side wall, a second side wall opposite the first side wall, a lower wall opposite the upper wall, a first rib extending from each of the lower wall and the first side wall, and a second rib extending from each of the lower wall and the second side wall.

9. The tool support device of claim 8, wherein the plurality of coupling structures are configured to detachably couple to a first male coupling structure coupled to an object.

10. The tool support device of claim 8, wherein the plurality of coupling structures are configured to detachably couple to a plurality of male coupling structures coupled to a plurality of objects.

11. The tool support device of claim 8, wherein for each of the plurality of coupling structures, the first rib extends a first horizontal distance from the first side wall towards the second side wall, and the first rib extends a first vertical distance from the lower wall towards the upper wall, and wherein the first vertical distance is greater than the first horizontal distance.

12. The tool support device of claim 11, wherein the first vertical distance is at least twice as far as the first horizontal distance.

13. The tool support device of claim 11, wherein for each of the plurality of coupling structures, the second rib extends a second horizontal distance from the second side wall towards the first side wall, and wherein the first vertical distance is greater than the second horizontal distance.

14. The tool support device of claim 13, wherein the second horizontal distance equals the first horizontal distance.

15. The tool support device of claim 8, the plurality of coupling structures comprising a first row of coupling structures arranged along a first horizontal axis, wherein the plate slides along a sliding axis with respect to the wall of the motor vehicle, and wherein the first horizontal axis is parallel to the sliding axis.

16. The tool support device of claim 15, the plurality of coupling structures comprising a first column of coupling structures arranged along a first vertical axis, wherein the first vertical axis is perpendicular to the sliding axis.

17. The tool support device of claim 8, the plurality of coupling structures comprising a plurality of rows of coupling structures arranged along horizontal axes, wherein the plate slides along a sliding axis with respect to the wall of the motor vehicle, and wherein the horizontal axes are parallel to the sliding axis.

18. A container comprising:
a base configured to be slidably coupled to a horizontal support surface of a motor vehicle;
a plurality of arms extending upward from the base; and
a plurality of rails extending horizontally between the plurality of arms, each rail of the plurality of rails comprising a body extending between and coupled to the arms, an upper projection extending upward and laterally from the body, and a lower projection extending downward and laterally from the body, the plurality of rails configured to detachably engage with support elements that are coupled to objects.

19. The container of claim 18, wherein for each of the plurality of rails, the body extends laterally along a first horizontal axis, and wherein the upper projection extends laterally along a second horizontal axis parallel to the first horizontal axis.

20. The container of claim 18, wherein for each of the plurality of rails, the body extends inwardly from the plurality of arms into an internal compartment of the container, and wherein for each of the plurality of rails, the upper projection extends inwardly from the body into an internal compartment of the container.
